(19) United States
(12) Patent Application Publication
(10) Pub. No.: US 2008/0192270 A1
(43) Pub. Date: Aug. 14, 2008

(54) TRANSPORT AMOUNT CORRECTING METHOD, TRANSPORT AMOUNT CORRECTING APPARATUS, AND STORAGE MEDIUM HAVING PROGRAM STORED THEREON

(75) Inventors: Tatsuya NAKANO, Nagano-ken (JP); Bunji Ishimoto, Matsimoto-shi (JP); Masahiko Yoshida, Shiojiri-shi (JP); Toru Miyamoto, Shiojiri-shi (JP); Hirokazu Nunokawa, Matumoto-shi (JP); Yoichi Kakehashi, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignee: Seiko Epson Corporation, Tokyo (JP)

(21) Appl. No.: 11/840,352

(22) Filed: Aug. 17, 2007

(30) Foreign Application Priority Data
Aug. 21, 2006 (JP) 2006-224544

(51) Int. Cl. G06F 15/00

(52) U.S. Cl. 358/1.9

(57) ABSTRACT

A transport amount correcting method is provided that includes: (A) determining whether or not correction values associated with relative positions of a head and a medium are stored in a memory, wherein the correction values are correction values for correcting target transport amounts when transporting the medium, and the medium is of a predetermined combination of a type and size of the medium; and (B) transporting, when carrying out transport of the medium of the predetermined combination, the medium while correcting a target transport amount using a correction value corresponding to a relative position at a time of carrying out the transport, and transporting, when carrying out transport of a medium other than the predetermined combination, the medium while correcting the target transport amount using a fixed correction value.

### CROSS-REFERENCE TO RELATED APPLICATION

The present application claims priority upon Japanese Patent Application No. 2006-224544 filed on Aug. 21, 2006, which is herein incorporated by reference.

### BACKGROUND

1. Technical Field

The present invention relates to transport amount correcting methods, transport amount correcting apparatuses, and storage media having a program stored thereon.

2. Related Art

Inkjet printers are known as recording apparatuses in which a medium (such as paper or cloth for example) is transported in a transport direction and recording is carried out on the medium with a head. When a transport error occurs while transporting the medium in a recording apparatus such as this, the head cannot record on a correct position on the medium. In particular, with inkjet printers, when ink droplets do not land in the correct position on the medium, there is a risk that white streaks or black streaks will occur in the printed image and picture quality will deteriorate.

Accordingly, methods of correcting transport amounts of the medium are proposed. For example, JP-A-5-96796 proposes that a test pattern is printed, then the test pattern is read and correction values are calculated based on the reading result such that when an image is to be recorded, the transport amounts are corrected based on the calculated values.

In this regard, in correcting the transport amount using the position of the medium, it is necessary to store correction values corresponding to each position of the medium. However, due to memory capacity restrictions, there are cases where correction values for all combinations of medium types and sizes cannot be stored. It would be useful to be able to correct transport amounts to a certain extent even when carrying out transport for a medium of a combination for which correction values could not be stored in the memory.

### SUMMARY

The present invention has been devised in light of these circumstances and it is an advantage therein to provide an apparatus capable of carrying out transport that has been corrected to a certain extent for a medium other than that of combinations for which correction values are stored even in a case where correction values for all combinations of medium types and sizes cannot be stored due to memory capacity restrictions.

In order to achieve the above-described object, a primary aspect of the invention is directed to a transport amount correcting method that includes:

(A) determining whether or not correction values associated with relative positions of a head and a medium are stored in a memory, the correction values being correction values for correcting target transport amounts when transporting the medium, the medium being of a predetermined combination of a type and size of the medium; and

(B) transporting, when carrying out transport of the medium of the predetermined combination, the medium while correcting a target transport amount using a correction value corresponding to a relative position at a time of carrying out the transport, and

transporting, when carrying out transport of a medium other than the predetermined combination, the medium while correcting the target transport amount using a fixed correction value.

Other features of the invention will become clear through the accompanying drawings and the following description.

### BRIEF DESCRIPTION OF THE DRAWINGS

FIG. 1 is a block diagram of an overall configuration of a printer 1.

FIG. 2A is a schematic view of the overall configuration of the printer 1. And FIG. 2B is a cross-sectional view of the overall configuration of the printer 1.

FIG. 3 is an explanatory diagram showing an arrangement of nozzles.

FIG. 4 is an explanatory diagram of a configuration of a transport unit 20.

FIG. 5 is a graph for describing AC component transport error.

FIG. 6 is a graph (schematic diagram) of transport error produced when transporting a paper.

FIG. 7 is a flowchart showing up to determining the correction values for correcting transport amounts.

FIGS. 8A to 8C are explanatory diagrams of conditions up to determining correction values.

FIG. 9 is an explanatory diagram illustrating a state of printing of a measurement pattern.

FIG. 10A is a vertical cross-sectional view of a scanner 150. FIG. 10B is a top view of the scanner 150 with an upper cover 151 removed.

FIG. 11 is a graph of scanner reading position error.

FIG. 12A is an explanatory diagram for a standard sheet SS. FIG. 12 B is an explanatory diagram of a condition in which a test sheet TS and a standard sheet SS are set on an original plate glass 152.

FIG. 13 is a flowchart of a correction value calculating process in S103.

FIG. 14 is an explanatory diagram of image division (S131).

FIG. 15A is an explanatory diagram of a state in which tilt of an image of the measurement pattern is detected. FIG. 15B is a graph of tone values of extracted pixels.

FIG. 16 is an explanatory diagram of a state in which tilt during printing of the measurement pattern is detected.

FIG. 17 is an explanatory diagram of a white space amount X.

FIG. 18A is an explanatory diagram of an image range used in calculating line positions. FIG. 18B is an explanatory diagram of calculating line positions.

FIG. 19 is an explanatory diagram of calculated line positions.

FIG. 20 is an explanatory diagram of calculating absolute positions of an i-th line in the measurement pattern.

FIG. 21 is an explanatory diagram of a range corresponding to correction values C(i).

FIG. 22 is an explanatory diagram of a table stored in the memory 63.

FIG. 23A is an explanatory diagram of correction values in a first case.

FIG. 23B is an explanatory diagram of correction values in a second case.

FIG. 23C is an explanatory diagram of correction values in a third case.

FIG. 23D is an explanatory diagram of correction values in a fourth case.

FIG. 24 is a table showing numbers in a correction value table that is stored for combinations of medium types and sizes.

FIG. 25 is a flowchart for describing transport amount corrections according to a first embodiment.

FIG. 26 is a flowchart for describing transport amount corrections according to a second embodiment.

FIG. 27 is an explanatory diagram of a range corresponding to correction values C(i) in an L-size.

FIG. 28 shows an L-size correction value table generated based on a 4×6 size correction value table.

### DESCRIPTION OF EMBODIMENTS

At least the following matters will be made clear by the description in the present specification and the description of the accompanying drawings.

A transport amount correcting method, including:

(A) determining whether or not correction values associated with relative positions of a head and a medium are stored in a memory, the correction values being correction values for correcting target transport amounts when transporting the medium, the medium being of a predetermined combination of a type and size of the medium; and

(B) transporting, when carrying out transport of the medium of the predetermined combination, the medium while correcting a target transport amount using a correction value corresponding to a relative position at a time of carrying out the transport, and

transporting, when carrying out transport of a medium other than the predetermined combination, the medium while correcting the target transport amount using a fixed correction value.

By doing this, transport can be carried out that has been corrected to a certain extent for a medium other than that of combinations for which correction values are stored even in a case where correction values for all combinations of medium types and sizes cannot be stored due to memory capacity restrictions.

Furthermore, it is preferable that with respect to each of the correction values, a range of the relative position to which the correction value should be applied is associated with the correction value, and in the case the range of the correction value corresponding to the relative position before transport is exceeded when performing transport using the target transport amount, the target transport amount is corrected based on the correction value corresponding to the relative position before transport and the correction value corresponding to the relative position after transport.

Furthermore, it is preferable that with respect to each of the correction values, a range of the relative position to which the correction value should be applied is associated with the correction value, and correction of the target transport amount is performed by weighting the correction values in accordance with a ratio between a range in which the relative position varies when performing transport using the target transport amount and the range of the relative position to which the correction value should be applied.

Furthermore, it is preferable that the medium is transported in a transport direction by causing a transport roller to rotate, each of the correction values are determined based on transport error when the medium has been transported by causing the transport roller to perform a single rotation, and a range of the relative position to which the correction value is to be applied corresponds to a transport amount of when the medium has been transported by causing the transport roller to rotate by a rotation amount of less than one rotation.

Furthermore, it is preferable that when carrying out transport of the medium other than the predetermined combination, a new target transport amount is obtained by multiplying a fixed correction value by the target transport amount and the medium is transported with the transport mechanism in response to the new target transport amount.

Furthermore, it is preferable that the medium of the predetermined combination includes a medium of a certain predetermined combination and a medium of a different predetermined combination, when transporting the medium of the certain predetermined combination, the medium is transported by correcting the target transport amount using correction values corresponding to the relative positions at a time of carrying out the transport, and when transporting the medium of the different predetermined combination, the medium is transported by correcting the target transport amount using a portion of correction values that correspond to the relative positions at a time of transporting the medium of the certain predetermined combination.

By doing this, transport can be carried out that has been corrected to a certain extent for a medium other than that of combinations for which correction values are stored even in a case where correction values for all combinations of medium types and sizes cannot be stored due to memory capacity restrictions.

A transport amount correcting apparatus, including:

(A) a head;

(B) a transport mechanism that transports a medium in a transport direction with respect to the head in accordance with a target transport amount that is targeted;

(C) a memory that stores a plurality of correction values associated with relative positions of the head and the medium, the correction values being correction values for correcting target transport amounts when transporting the medium, the medium being of a predetermined combination of a type and size of the medium; and

(D) a controller that, when carrying out transport of the medium of the predetermined combination, causes the transport mechanism to transport the medium while correcting a target transport amount using a correction value corresponding to a relative position at a time of carrying out the transport, and

when carrying out transport of a medium other than the predetermined combination, causes the transport mechanism to transport the medium while correcting the target transport amount using a fixed correction value.

By doing this, transport can be carried out that has been corrected to a certain extent for a medium other than that of combinations for which correction values are stored even in a case where correction values for all combinations of medium types and sizes cannot be stored due to memory capacity restrictions.

A storage medium having a program stored thereon, provided with:

(A) code for determining whether or not correction values associated with relative positions of a head and a medium are stored in a memory, the correction values being correction values for correcting target transport amounts when transporting the medium, the medium being of a predetermined combination of a type and size of the medium; and

(B) code for transporting, when carrying out transport of the medium of the predetermined combination, the medium while correcting a target transport amount using a correction value corresponding to a relative position at a time of carrying out the transport, and

transporting, when carrying out transport of a medium other than the predetermined combination, the medium while correcting the target transport amount using a fixed correction value.

By doing this, transport can be carried out that has been corrected to a certain extent for a medium other than that of combinations for which correction values are stored even in a case where correction values for all combinations of medium types and sizes cannot be stored due to memory capacity restrictions.

Configuration of the Printer

Regarding the Configuration of the Inkjet Printer

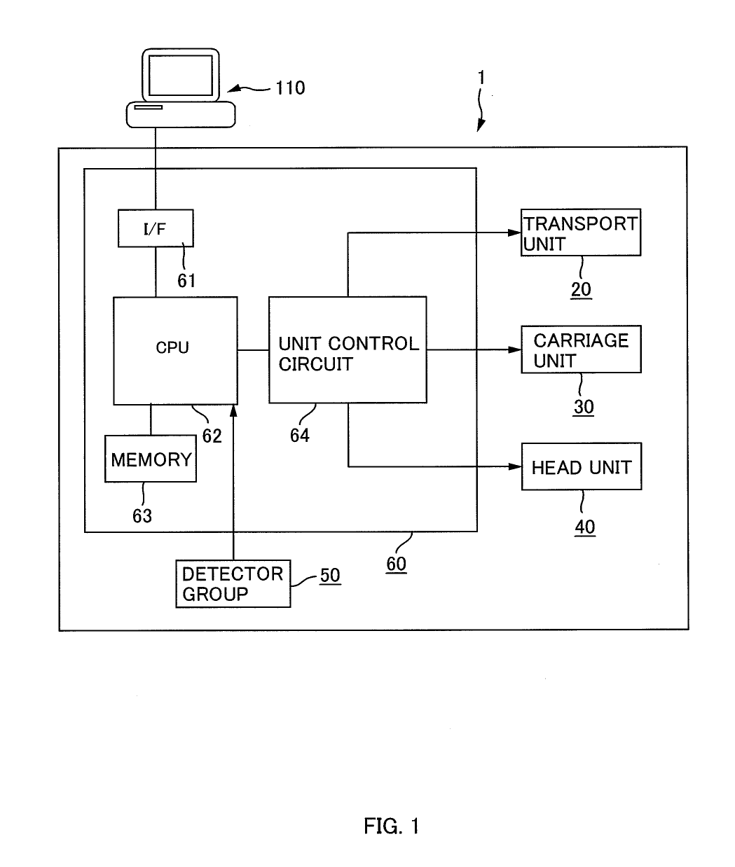

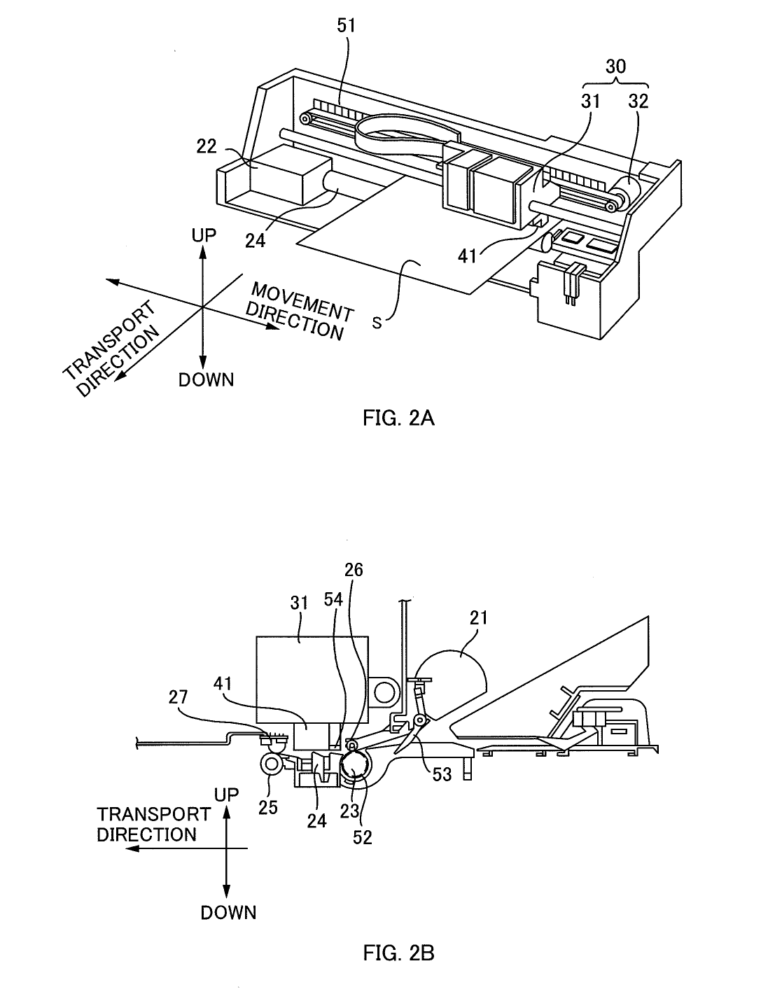

FIG. 1 is a block diagram of an overall configuration of a printer 1. FIG. 2A is a schematic view of the overall configuration of the printer 1. FIG. 2B is a cross-sectional view of the overall configuration of the printer 1. Hereinafter, the basic configuration of the printer is described.

The printer 1 has a transport unit 20, a carriage unit 30, a head unit 40, a detector group 50, and a controller 60. The printer 1, which receives print data from a computer 110, which is an external device, controls the various units (the transport unit 20, the carriage unit 30, and the head unit 40) using the controller 60. The controller 60 controls the units based on the print data received from the computer 110, to form an image on paper. The detector group 50 monitors the conditions within the printer 1, and outputs the detection results to the controller 60. The controller 60 controls the units based on the detection results output from the detector group 50.

The transport unit 20 is for transporting a medium (for example, such as paper S) in a predetermined direction (hereinafter referred to as a “transport direction”). The transport unit 20 has apaper-feed roller 21, a transport motor 22 (hereinafter also referred to as PF motor), a transport roller 23, a platen 24, and a discharge roller 25. The paper feed roller 21 is a roller for feeding paper that has been inserted into a paper insert opening into the printer. The transport roller 23 is a roller for transporting the paper S that has been supplied by the paper supply roller 21 up to a printable region, and is driven by the transport motor 22. The platen 24 supports the paper S during printing. The discharge roller 25 is a roller for discharging the paper S to outside the printer, and is provided on the transport direction downstream side of the printable region. The discharge roller 25 is rotated in synchronization with the transport roller 23.

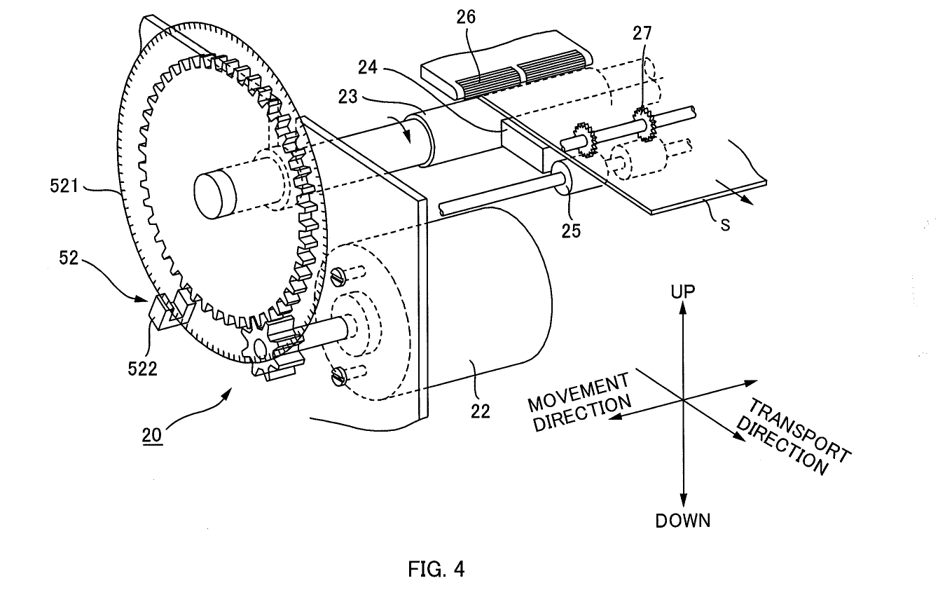

It should be noted that when the transport roller 23 transports the paper S, the paper S is sandwiched between the transport roller 23 and a driven roller 26. In this way, the posture of the paper S is kept stable. On the other hand, when the discharge roller 25 transports the paper S, the paper S is sandwiched between the discharge roller 25 and a driven roller 27. The discharge roller 25 is provided on a downstream side from the printable region in the transport direction and therefore the driven roller 27 is configured so that its contact surface with the paper S is small (see FIG. 4). For this reason, when the lower end of the paper S passes the transport roller 23 and the paper S becomes transported by the discharge roller 25 only, the posture of the paper S tends to become unstable, which also tends to make the transport characteristics fluctuate.

The carriage unit 30 is for making the head move (also referred to as “scan”) in a predetermined direction (hereinafter, referred to as the “movement direction”). The carriage unit 30 has a carriage 31 and a carriage motor 32 (also referred to as “CR motor”). The carriage 31 can move in a reciprocating manner along the movement direction, and is driven by the carriage motor 32. Furthermore, the carriage 31 detachably retains an ink cartridge containing ink.

The head unit 40 is for ejecting ink onto paper. The head unit 40 is provided with a head 41 including a plurality of nozzles. The head 41 is provided to the carriage 31 so that when the carriage 31 moves in the movement direction, the head 41 also moves in the movement direction. Then, dot lines (raster lines) are formed on the paper in the movement direction as a result of the head 41 intermittently ejecting ink while moving in the movement direction.

The detector group 50 includes a linear encoder 51, a rotary encoder 52, a paper detection sensor 53, and an optical sensor 54, for example. The linear encoder 51 is for detecting the position of the carriage 31 in the movement direction. The rotary encoder 52 is for detecting the amount of rotation of the transport roller 23. The paper detection sensor 53 detects the position of the front end of the paper that is being fed. The optical sensor 54 detects whether or not the paper is present by a light-emitting section and a light-receiving section provided in the carriage 31. The optical sensor 54 can also detect the width of the paper by detecting the position of the end portions of the paper while being moved with the carriage 31. Depending on the circumstances, the optical sensor 54 can also detect the front end of the paper (the end portion on the transport direction downstream side; also called the upper end) and the rear end of the paper (the end portion on the transport direction upstream side; also called the lower end).

The controller 60 is a control unit (controller) for controlling the printer. The controller 60 has an interface section 61, a CPU 62, a memory 63, and a unit control circuit 64. The interface section 61 exchanges data between the computer 110, which is an external device, and the printer 1. The CPU 62 is a computer processing device for carrying out overall control of the printer. The memory 63 is for reserving a working region and a region for storing the programs for the CPU 62, for instance, and has a memory means such as a RAM or an EEPROM. The CPU 62 controls each unit via the unit control circuit 64 according to a program stored in the memory 63.

Regarding the Nozzles

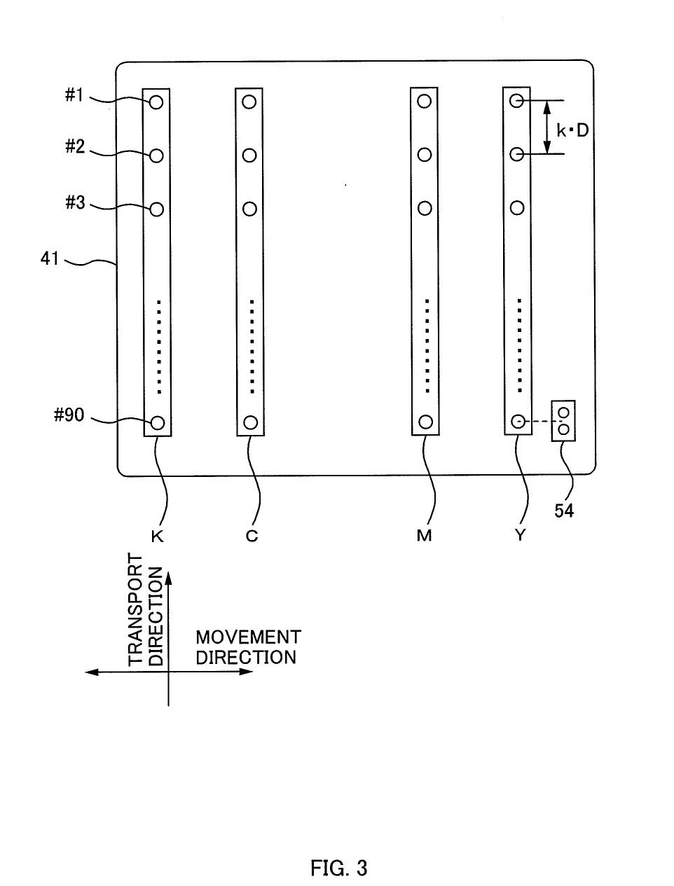

FIG. 3 is an explanatory diagram showing the arrangement of the nozzles in the lower surface of the head 41. A black ink nozzle group K, a cyan ink nozzle group C, a magenta ink nozzle group M, and a yellow ink nozzle group Y are formed in the lower surface of the head 41. Each nozzle group is provided with 90 nozzles that are ejection openings for ejecting inks of various colors.

The plurality of nozzles of the nozzle groups are arranged in rows at a constant spacing (nozzle pitch: k·D) in the transport direction. Here D is the minimum dot pitch in the transport direction (that is, the spacing at the maximum resolution of dots formed on the paper S). Also, k is an integer of 1 or more. For example, if the nozzle pitch is 90 dpi ( 1/90 inch) and the dot pitch in the transport direction is 720 dpi ( 1/720), then k=8.

The nozzles of each of the nozzle groups are assigned a number (#1 through #90) that becomes smaller for nozzles further downstream. That is, the nozzle #1 is positioned more downstream in the transport direction than the nozzle #90. Also, the optical sensor 54 is provided substantially to the same position as the nozzle #90, which is on the side furthest upstream, as regards the position in the paper transport direction.

Each nozzle is provided with an ink chamber (not shown) and a piezo element. Driving the piezo element causes the ink chamber to expand and contract, thereby ejecting an ink droplet from the nozzle.

Transport Error

Regarding Paper Transport

FIG. 4 is an explanatory diagram of a configuration of the transport unit 20.

The transport unit 20 drives the transport motor 22 by predetermined drive amounts in accordance with a transport command from the controller 60. The transport motor 22 generates a drive force in the rotation direction that corresponds to the drive amount that has been ordered. The transport motor 22 then rotates the transport roller 23 using this drive force. That is, when the transport motor 22 generates a predetermined drive amount, the transport roller 23 is rotated by a predetermined rotation amount. When the transport roller 23 is rotated by the predetermined rotation amount, the paper is transported by a predetermined transport amount.

The amount that the paper is transported is determined according to the rotation amount of the transport roller 23. Here, when the transport roller 23 rotates one time, the paper is transported one inch (that is, the circumference of the transport roller 23 is one inch). Thus, when the transport roller 23 rotates one quarter, the paper is transported ¼ inch.

Consequently, if the rotation amount of the transport roller 23 can be detected then it is also possible to detect the transport amount of the paper. Accordingly, the rotary encoder 52 is provided in order to detect the rotation amount of the transport roller 23.

The rotary encoder 52 has a scale 521 and a detection section 522. The scale 521 has numerous slits provided at a predetermined spacing. The scale 521 is provided in the transport roller 23. That is, the scale 521 rotates together with the transport roller 23 when the transport roller 23 is rotated. Then, when the transport roller 23 rotates, each slit on the scale 521 successively passes through the detection section 522. The detection section 522 is provided in opposition to the scale 521, and is fastened on the main printer unit side. The rotary encoder 52 outputs a pulse signal each time a slit provided in the scale 521 passes through the detection section 522. Since the slits provided in the scale 521 successively pass through the detection section 522 according to the rotation amount of the transport roller 23, the rotation amount of the transport roller 23 is detected based on the output of the rotary encoder 52.

Then, when the paper is to be transported by a transport amount of one inch for example, the controller 60 drives the transport motor 22 until the rotary encoder 52 detects that the transport roller 23 has rotated one time. In this manner, the controller 60 drives the transport motor 22 until a transport amount corresponding to a targeted transport amount (target transport amount) is detected by the rotary encoder 52 such that the paper is transported by the target transport amount.

Regarding Transport Error

Incidentally, the rotary encoder 52 directly detects the rotation amount of the transport roller 23, and strictly speaking does not detect the transport amount of the paper S. For this reason, when the rotation amount of the transport roller 23 and the transport amount of the paper S do not match, the rotary encoder 52 cannot accurately detect the transport amount of the paper S, resulting in a transport error (detection error). There are two types of transport error, DC component transport error and AC component transport error.

DC component transport error refers to a predetermined amount of transport error produced when the transport roller has rotated one time. The DC component transport error would seem to be caused by the circumference of the transport roller 23 being different in each individual printer due to deviation in production and the like. In other words, the DC component transport error is transport error that occurs because the circumference of the transport roller 23 in design and the actual circumference of the transport roller 23 are different. The DC component transport error is constant regardless of the commencement position when the transport roller 23 rotates one time. However, due to the effect of paper friction and the like, the actual DC component transport error is a value that varies in response to a total transport amount of the paper (discussed later). In other words, the actual DC component transport error is a value that varies in response to the relative position relationship between the paper S and the transport roller 23 (or the paper S and the head 41).

AC component transport error refers to transport error corresponding to a location on a circumferential surface of the transport roller that is used when transporting. AC component transport error varies in amount in response to the location on the circumferential surface of the transport roller that is used when transporting. That is, the AC component transport error is an amount that varies in response to the rotation position and transport amount of the transport roller when transport commences.

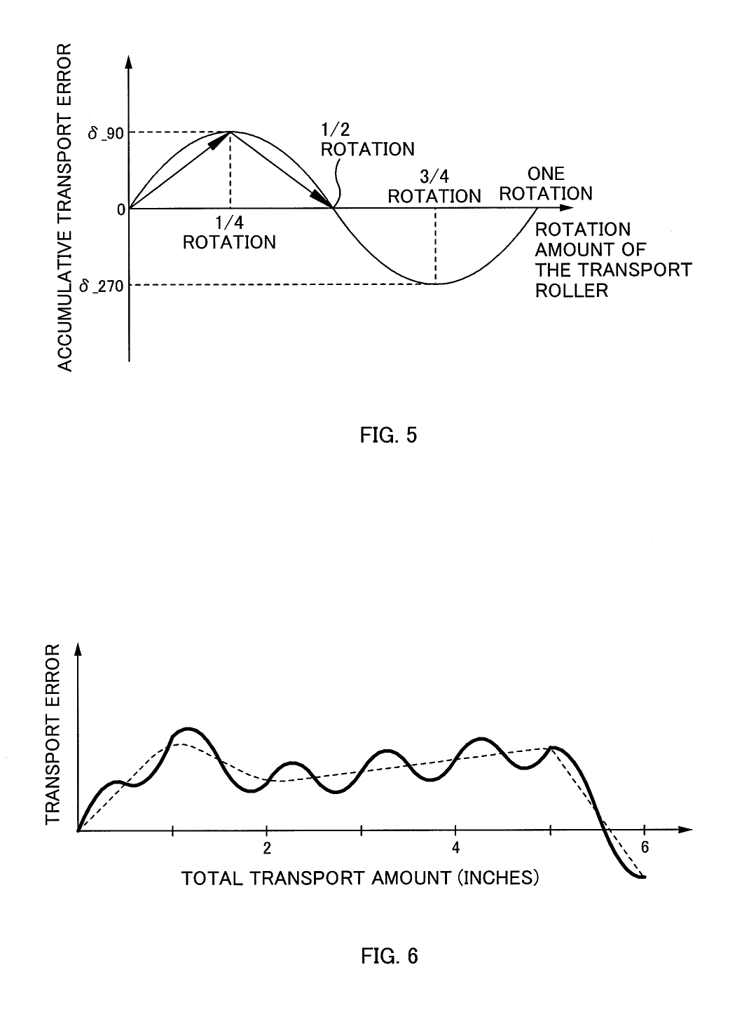

FIG. 5 is a graph for describing AC component transport error. The horizontal axis indicates the rotation amount of the transport roller 23 from a reference rotation position. The vertical axis indicates transport error. When the graph is differentiated, the transport error produced when the transport roller rotates at the rotation position is deduced. Here, accumulative transport error at the reference position is set to zero and the DC component transport error is also set to zero.

When the transport roller 23 performs a ¼ rotation from the reference position, a transport error of δ_{—}90 is produced, and the paper is transported ¼ inch+δ_{—}90. However, when the transport roller 23 performs a further ¼ rotation, a transport error of −δ_{—}90 is produced, and the paper is transported ¼ inch−δ_{—}90.

The following three causes for example are conceivable as causes of AC component transport error.

First, influence due to the shape of the transport roller is conceivable. For example, when the transport roller is elliptical or egg shaped, the distance to the rotational center varies in response to the location on the circumferential surface of the transport roller. And when the medium is transported at an area where the distance to the rotational center is long, the transport amount increases with respect to the rotation amount of the transport roller. On the other hand, when the medium is transported at an area where the distance to the rotational center is short, the transport amount decreases with respect to the rotation amount of the transport roller.

Secondly, the eccentricity of the rotational axis of the transport roller is conceivable. In this case too, the length to the rotational center varies in response to the location on the circumferential surface of the transport roller. For this reason, even if the rotation amount of the transport roller is the same, the transport amount varies in response to the location on the circumferential surface of the transport roller.

Thirdly, inconsistency between the rotational axis of the transport roller and the center of the scale 521 of the rotary encoder 52 is conceivable. In this case, the scale 521 rotates eccentrically. As a result, the rotation amount of the transport roller 23 varies with respect to the detected pulse signals in response to the location of the scale 521 detected by the detection section 522. For example, when the detected location of the scale 521 is apart from the rotational axis of the transport roller 23, the rotation amount of the transport roller 23 becomes smaller with respect to the detected pulse signals, and therefore the transport amount becomes smaller. On the other hand, when the detected location of the scale 521 is close to the rotational axis of the transport roller 23, the rotation amount of the transport roller 23 becomes larger with respect to the detected pulse signals, and therefore the transport amount becomes larger.

As a result of these causes, the AC component transport error forms substantially a sine curve as shown in FIG. 5.

Transport Error Corrected in a Reference Example

FIG. 6 is a graph (conceptual diagram) of transport error produced when transporting a paper of a size 101.6 mm×152.4 mm (4×6 inches). The horizontal axis in the graph indicates a total transport amount of the paper. The vertical axis in the graph indicates transport error. The dotted line in the diagram is a graph of the DC component transport error. The AC component transport error is obtainable by subtracting the dotted line values (DC component transport error) in the drawing from the solid line values (total transport error) in the drawing. Regardless of the total transport amount of the paper, the AC component transport error forms substantially a sine curve. On the other hand, due to the effect of paper friction and the like, the DC component transport error indicated by the dotted line is a value that varies in response to the total transport amount of the paper.

As has been described, AC component transport error varies in response to the location on the circumferential surface of the transport roller 23. For this reason, even when transporting papers that are the same, the AC component transport error will vary if there are different rotation positions on the transport roller 23 at the commencement of transport, and therefore the total transport error (transport error indicated by a solid line on the graph) will vary. In contrast to this, unlike AC component transport error, DC component transport error has no relation to the location on the circumferential surface of the transport roller, and therefore even if the rotation position of the transport roller 23 varies at the commencement of transport, the transport error (DC component transport error) produced when the transport roller rotates one time is the same.

Furthermore, when attempting to correct AC component transport error, it is necessary for the controller 60 to detect the rotation position of the transport roller 23. However, to detect the rotation position of the transport roller 23 it is necessary to further prepare an origin sensor for the rotary encoder 52, which results in increased costs.

Consequently, in the transport amount corrections shown below in the reference example, DC component transport error is corrected.

On the other hand, DC component transport error is a value that varies (see the dotted line in FIG. 6) in response to the total transport amount of the paper (in other words, the relative position relationship between the paper S and the transport roller 23). For this reason, if a greater number of correction values can be prepared corresponding to transport direction positions, fine corrections of transport error can be achieved. Consequently, in the reference example, correction values for correcting DC component transport error are prepared for each ¼ inch range rather than for each one inch range corresponding to a single rotation of the transport roller 23.

### Outline Description

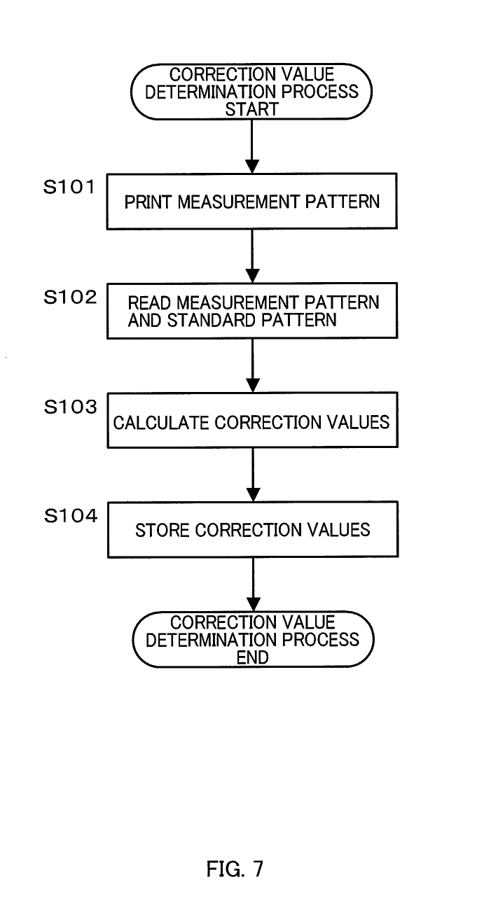

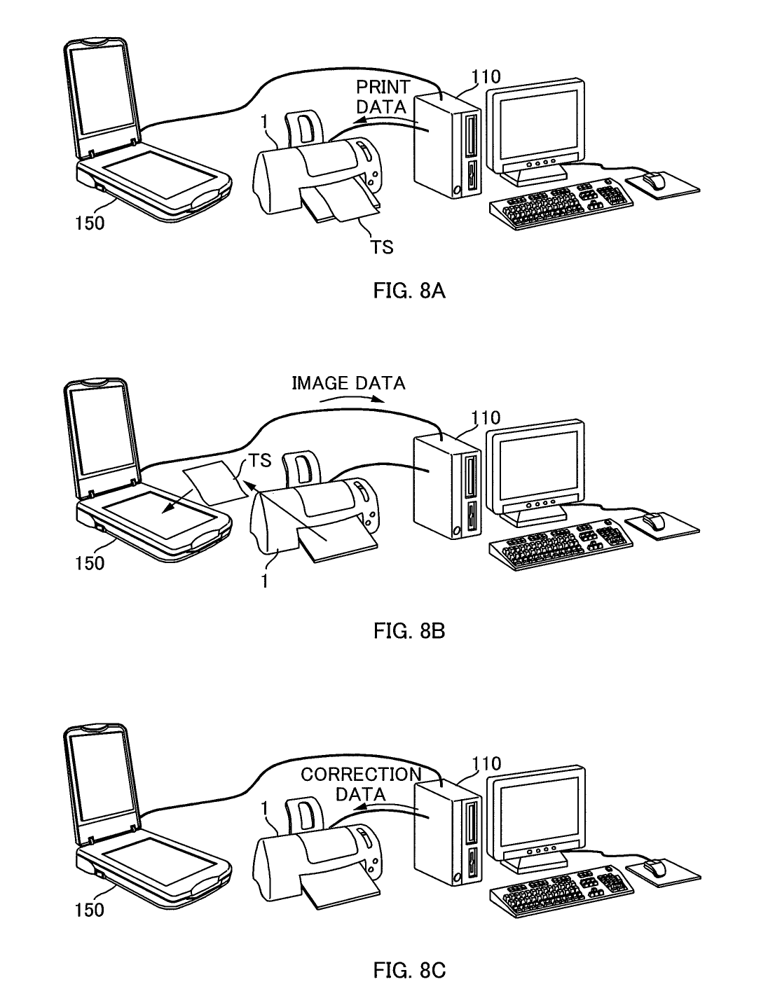

FIG. 7 is a flowchart showing up to determining the correction values for correcting transport amounts. FIGS. 8A to 8C are explanatory diagrams of conditions up to determining correction values. These processes are performed in an inspection process at a printer manufacturing factory. Prior to this process, an inspector connects a printer 1 that is fully assembled to a computer 110 at the factory. The computer 110 at the factory is connected to a scanner 150 and is preinstalled with a printer driver, a scanner driver, and a program for obtaining correction values.

First, the printer driver sends print data to the printer 1 and the printer 1 prints (S101, FIG. 8A) a measurement pattern on a test sheet TS. Next, the inspector sets the test sheet TS in the scanner 150 and the scanner driver causes the measurement pattern to be read with the scanner 150 such that image data is obtained (S102, FIG. 8B). It should be noted that a standard sheet is set in the scanner 150 along with the test sheet TS, and a standard pattern drawn on the standard sheet is also read together.

Then, the program for obtaining correction values analyzes the image data that has been obtained and calculates correction values (S103). Then the program for obtaining correction values sends the correction data to the printer 1 and the correction values are stored (FIG. 8C) in a memory 63 of the printer 1. The correction values stored in the printer reflect the transport characteristics of each individual printer.

It should be noted that the printer, which has stored correction values, is packaged and delivered to a user. When the user is to print an image with the printer, the printer transports the paper based on the correction values and prints the image onto the paper.

Measurement Pattern Printing (S101)

First, description is given concerning the printing of the measurement pattern. As with ordinary printing, the printer 1 prints the measurement pattern by alternately repeating a dot forming process, in which dots are formed by ejecting ink from moving nozzles, and a transport operation in which the paper is transported in the transport direction. It should be noted that in the description hereinafter, the dot forming process is referred to as a “pass” and an n-th dot forming process is referred to as “pass n.”

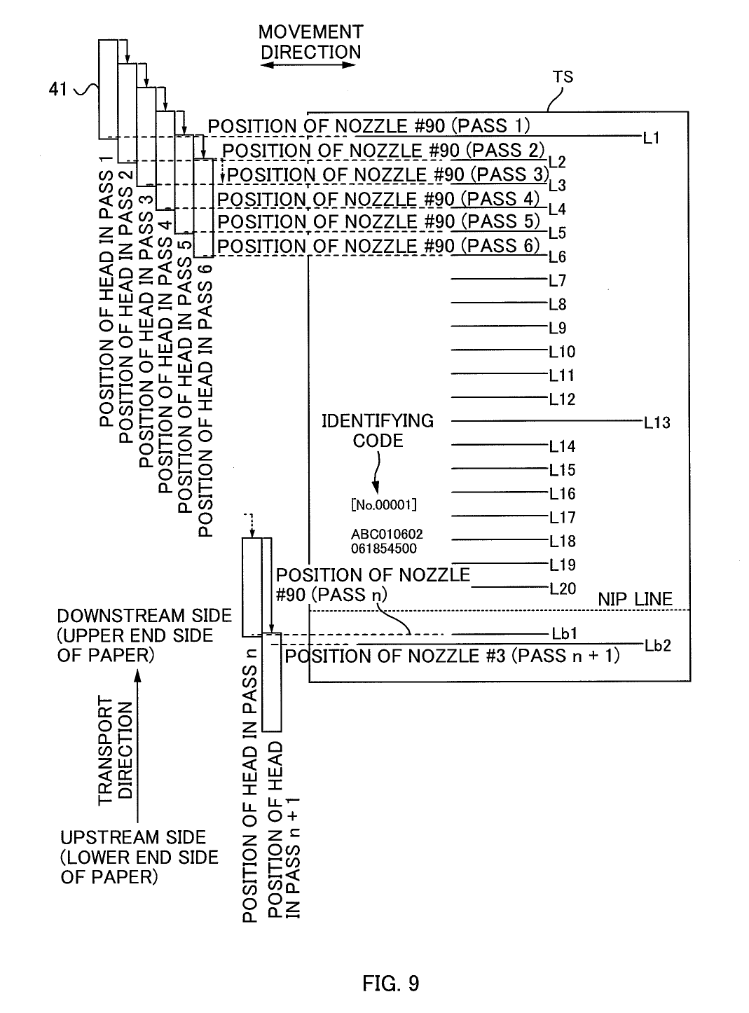

FIG. 9 is an explanatory diagram illustrating a state of printing of a measurement pattern. The size of a test sheet TS on which the measurement pattern is to be printed is 101.6 mm×152.4 mm (4×6 inches).

The measurement pattern printed on the test sheet TS is shown on the right side of FIG. 9. The rectangles on the left side of FIG. 9 indicate the position (the relative position with respect to the test sheet TS) of the head 41 at each pass. To facilitate description, the head 41 is illustrated as if moving with respect to the test sheet TS, but the FIG. 9 shows the relative positional relationship of the head and the test sheet TS and in fact the test sheet TS is being transported intermittently in the transport direction.

When the test sheet TS continues to be transported, the lower end of the test sheet TS passes over the transport roller 23. The position on the test sheet TS in opposition to the most upstream nozzle #90 when the lower end of the test sheet TS passes over the transport roller 23 is shown by a dotted line in FIG. 9 as a “NIP line.” That is, in passes where the head 41 is higher than the NIP line in FIG. 9, printing is carried out in a state in which the test sheet TS is sandwiched between the transport roller 23 and the driven roller 26 (also referred to as a “NIP state”). Furthermore, in passes where the head 41 is lower than the NIP line in FIG. 9, printing is carried out in a state in which the test sheet TS is not between the transport roller 23 and the driven roller 26 (which is a state in which the test sheet TS is transported by only the discharge roller 25 and the driven roller 27 and is also referred to as a “non NIP state”).

The measurement pattern is constituted by an identifying code and a plurality of lines.

The identifying code is a symbol for individual identification for identifying each of the individual printers 1 respectively. The identifying code is also read together when the measurement pattern is read at S102, and is identified in the computer 110 using OCR character recognition.

Each of the lines is formed in the movement direction. More lines are formed on the upper end side of the NIP line. Lines on the upper end side from the NIP line are numbered “Li” in order from the upper end side for each i-th line. Furthermore, two lines are formed on the lower end side from the NIP line. Of the two lines on the lower end side from the NIP line, the upper side line is numbered Lb1 and the lower side line (the lowest line) is numbered Lb2. Specific lines are formed longer than other lines. For example, line L1, line L13, and line Lb2 are formed longer compared to the other lines. These lines are formed as follows.

First, after the test sheet TS is transported to a predetermined print commencement position, ink droplets are ejected from nozzle #90 only in pass 1 thereby forming the line L1. After pass 1, the controller 60 causes the transport roller 23 to perform a ¼ rotation so that the test sheet TS is transported by approximately ¼ inch. First, after transport, ink droplets are ejected from only nozzle #90 in pass 2 thereby forming the line L2. Thereafter, the same operation is repeated and the lines L1 to L20 are formed at intervals of approximately ¼ inch. In this manner, the line L1 to line L20, which are on the upper end side from the NIP line, are formed using the most upstream nozzle #90 of the nozzles #1 to nozzle #90. In this way, the most lines possible can be formed on the test sheet TS in the NIP state. It should be noted that although line L1 to line L20 are formed using only nozzle #90, nozzles other than the nozzle #90 are used when printing the identifying code in the pass in which the identifying code is printed.

After the lower end of the test sheet TS has passed the transport roller 23, ink droplets are ejected from only nozzle #90 in pass n, thereby forming the line Lb1. After pass 1, the controller 60 causes the transport roller 23 to rotate one time so that the test sheet TS is transported by approximately one inch. After transport, ink droplets are ejected from only nozzle #3 in pass n+1, thereby forming the line Lb2. Supposing nozzle #1 was used, the interval between the line Lb1 and the line Lb2 would be extremely narrow (approximately 1/90 inch), which would make measuring difficult when the interval between the line Lb1 and the line Lb2 is measured later. For this reason, here, the interval between the line Lb1 and the line Lb2 is widened by forming the line Lb2 using nozzle #3, which is on the upstream side from the nozzle #1 in the transport direction, thereby facilitating measurement.

Incidentally, when transport of the test sheet TS is carried out ideally, the interval between the lines from line L1 to line L20 should be precisely ¼ inch. However, when there is transport error, the line interval is not ¼ inch. Suppose the test sheet TS is carried more than an ideal transport amount, then the line interval widens. Conversely, if the test sheet TS is carried less than an ideal transport amount, then the line interval narrows. That is, the interval between a certain two lines reflects the transport error in the transport process between a pass in which one of the lines is formed and a pass in which the other of the lines is formed. For this reason, by measuring the interval between two lines, it is possible to measure the transport error in the transport process between a pass in which one of the lines is formed and a pass in which the other of the lines is formed.

Similarly, the interval between the line Lb1 and the line Lb2 should be precisely 3/90 inch when transport of the test sheet TS is carried out ideally (or more accurately, when the ejection of ink from the nozzle #90 and nozzle #3 is also the same). However, when there is transport error, the line interval is not 3/90 inch. For this reason, it is conceivable that the interval between the line Lb1 and the line Lb2 reflects transport error in the transport process in a non NIP state. For this reason, if the interval between the line Lb1 and the line Lb2 is measured, it is possible to measure the transport error in the transport process in a non NIP state.

Pattern Reading (S102)

Scanner Configuration

First, description is given concerning the configuration of the scanner 150 used in reading the measurement pattern.

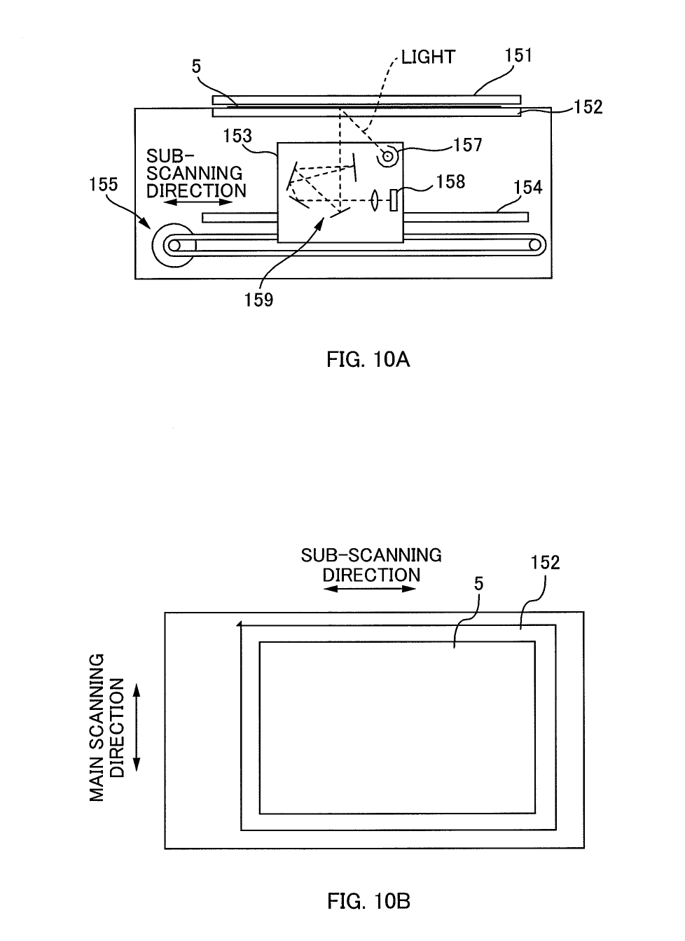

FIG. 10A is a vertical cross-sectional view of the scanner 150. FIG. 10B is a top view of the scanner 150 with an upper cover 151 removed.

The scanner 150 is provided with the upper cover 151, an original plate glass 152 on which an original 5 is placed, and a reading carriage 153 that moves in a sub-scanning direction while opposing the original 5 via the original table glass 152, a guiding member 154 that guides the reading carriage 153 in the sub-scanning direction, a moving mechanism 155 for moving the reading carriage 153, and a scanner controller (not shown) that controls each section of the scanner 150. The reading carriage 153 is provided with an exposure lamp 157 for irradiating the original 5 with light, a line sensor 158 that detects an image of a line in the main-scanning direction (direction perpendicular to the paper surface in FIG. 10A) and an optical system 159 for guiding light reflected by the original 5 to the line sensor 158. The broken line in the reading carriage 153 of FIG. 10A shows light trajectory.

When reading an image of the original 5, an operator opens the upper cover 151 and places the original 5 on the original plate glass 152, and closes the upper cover 151. Then, the scanner controller causes the reading carriage 153 to move in the sub-scanning direction while causing the exposure lamp 157 to emit light, and reads the image on the surface of the original 5 with the line sensor 158. The scanner controller transmits the image data that is read to a scanner driver of the computer 110, and the computer 110 obtains the image data of the original 5.

Positional Accuracy in Reading

As is described later, in this reference example, the scanner 150 scans the measurement pattern of the test sheet TS and the standard pattern of the standard sheet at a resolution of 720 dpi (main scanning direction)×720 dpi (sub-scanning direction). Thus, in the following description, description is given assuming image reading at a resolution of 720×720 dpi.

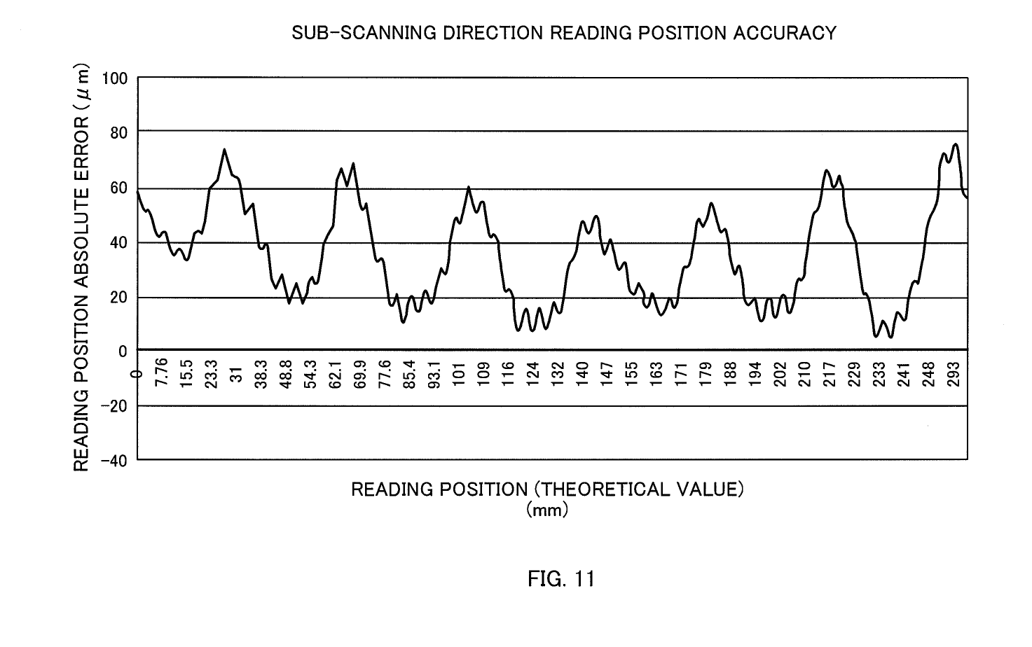

FIG. 11 is a graph of scanner reading position error. The horizontal axis in the graph indicates reading positions (theoretical values) (that is, the horizontal axis in the graph indicates positions (theoretical values) of the reading scanning 153). The vertical axis in the graph indicates reading position error (difference between the theoretical values of reading positions and actual reading positions). For example, when the reading carriage 153 is caused to move 1 inch (=25.4 mm), an error of approximately 60 μm is produced.

Suppose that the theoretical value of the reading position and the actual reading position match, a pixel that is 720 pixels apart in the sub-scanning direction from a pixel indicating a reference position (a position where the reading position is zero) should indicate an image in a position precisely one inch from the reference position. However, when reading position error occurs as shown in the graph, the pixel that is 720 pixels apart in the sub-scanning direction from the pixel indicating a reference position indicates an image in a position that is a further 60 μm apart from the position that is one inch apart from the reference position.

Furthermore, suppose that there is zero tilt in the graph, the image should be read having a uniform interval each 1/720 inch. However, when the graph tilt is in a positive position, the image is read having an interval longer than 1/720 inch. And when the graph tilt is in a negative position, the image is read having an interval shorter than 1/720 inch.

As a result, even supposing the lines of the measurement pattern are formed having uniform intervals, the line images in the image data will not have uniform intervals in a state in which there is reading position error. In this manner, in a state in which there is reading position error, line positions cannot be accurately measured by simply reading the measurement pattern.

Consequently, in this reference example, when the test sheet TS is set and the measurement pattern is read by the scanner, a standard sheet is set and a standard pattern is also read.

Reading the Measurement Pattern and the Standard Pattern

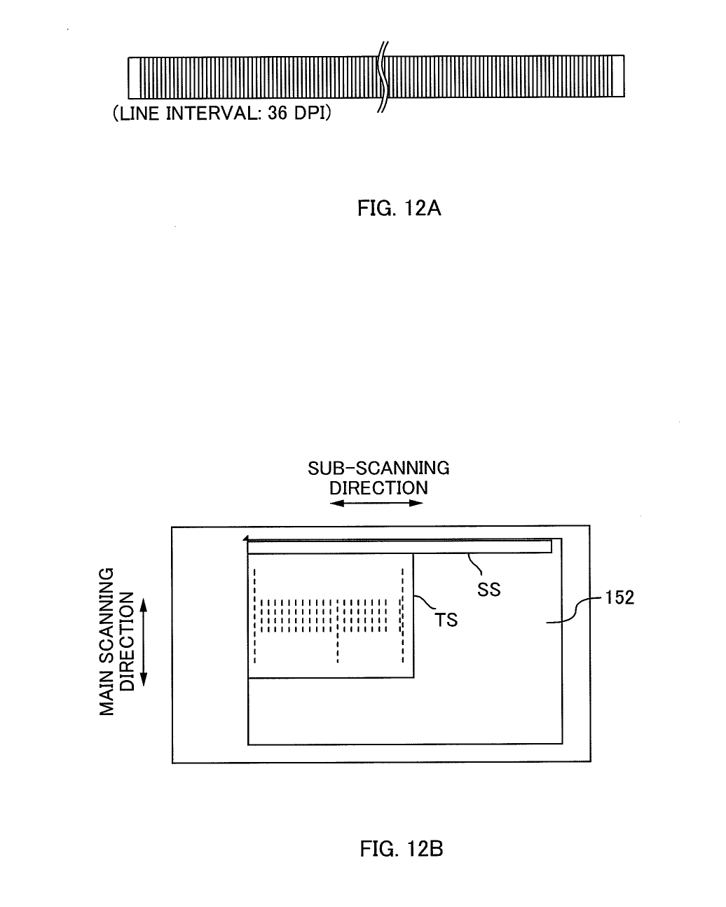

FIG. 12A is an explanatory diagram for a standard sheet SS. FIG. 12 B is an explanatory diagram of a condition in which a test sheet TS and a standard sheet SS are set on the original plate glass 152.

A size of the standard sheet SS is 10 mm×300 mm such that the standard sheet SS is a long narrow shape. A multitude of lines are formed as a standard pattern at intervals of 36 dpi on the standard sheet SS. Since it is used repetitively, the standard sheet SS is constituted not by paper but rather by a PET film. Furthermore, the standard pattern is formed with high precision using laser processing.

The test sheet TS and the standard sheet SS are set in a predetermined position on the original plate glass 152 using a jig not shown in the drawings. The standard sheet SS is set on the original plate glass 152 so that its long sides become parallel to the sub-scanning direction of the scanner 150, that is, so that each line of the standard sheet SS becomes parallel to the sub-scanning direction of the scanner 150. The test sheet TS is set beside the standard sheet SS. The test sheet TS is set on the original plate glass 152 so that its long sides become parallel to the sub-scanning direction of the scanner 150, that is, so that each line of the measurement pattern becomes parallel in the sub-scanning direction.

With the test sheet TS and the standard sheet SS set in this state, the scanner 150 reads the measurement pattern and the standard pattern. At this time, due to the influence of reading position error, the image of the measurement pattern in the reading result is a distorted image compared to the actual measurement pattern. Similarly, the image of the standard pattern is also a distorted image compared to the actual standard pattern.

It should be noted that the image of the measurement pattern in the reading result receives not only the influence of reading position error, but also the influence of transport error of the printer 1. On the other hand, the standard pattern is formed having a uniform interval without any relation to transport error of the printer, and therefore the image of the standard pattern receives the influence of reading position error in the scanner 150 but does not receive the influence of transport error of the printer 1.

Consequently, the program for obtaining correction values cancels the influence of reading position error in the image of the measurement pattern based on the image of the standard pattern when calculating correction values based on the image of the measurement pattern.

Calculation of Correction Values (S103)

Before describing the calculation of correction values, description is given concerning the image data obtained from the scanner 150. Image data is constituted by a plurality of pixel data. The data for each pixel indicates a tone value of the corresponding pixel. Ignoring scanner reading error, each pixel corresponds to a size of 1/720 inch× 1/720 inch. An image (digital image) is constituted having pixels such as these as a smallest structural unit, and image data is data that indicates an image such as this.

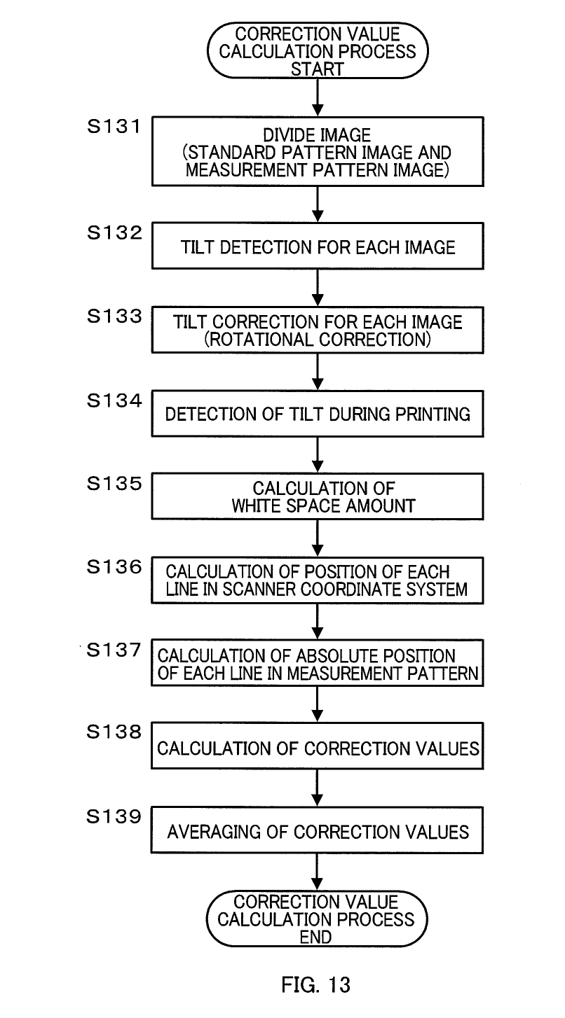

FIG. 13 is a flowchart of a correction value calculating process in S103. The computer 110 executes each process in accordance with the program for obtaining correction values. That is, the program for obtaining correction values contains code for causing each process to be executed in the computer 110.

Image Division (S131)

First, the computer 110 divides (S131) the image that indicates image data obtained from the scanner 150 into two.

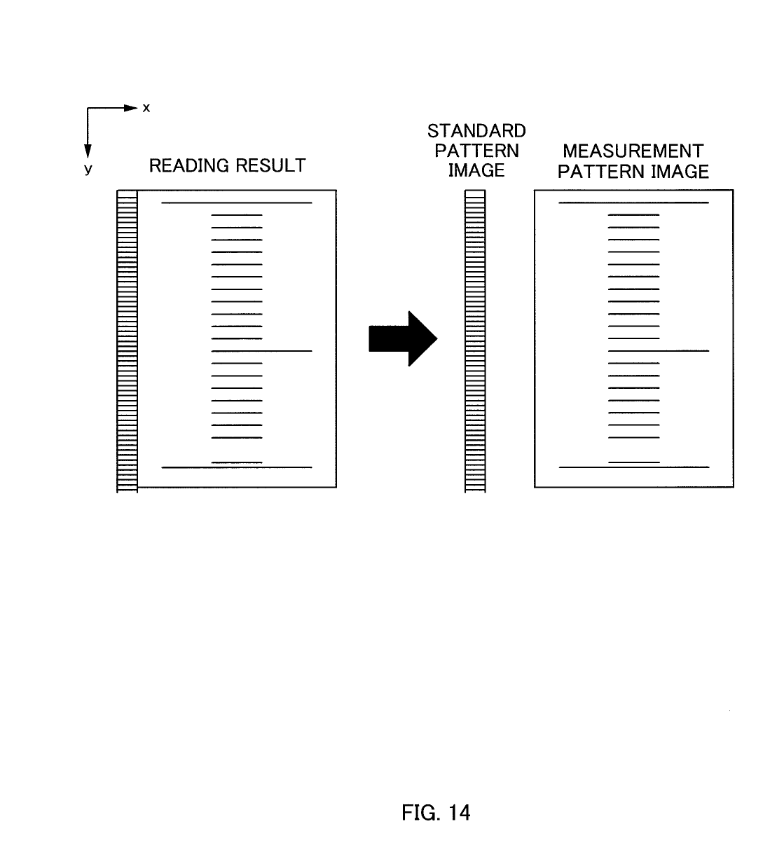

FIG. 14 is an explanatory diagram of image division (S131). On the left side of the diagram, an image is drawn indicating image data obtained from the scanner. On the right side of the diagram, a divided image is drawn. In the following description, the left-right direction (horizontal direction) in the drawing is referred to as the x direction and the up-down direction (vertical direction) in the drawing is referred to as the y direction. The lines in the image of the standard pattern are substantially parallel to the x direction and the lines in the image of the measurement pattern are substantially parallel to the y direction.

The computer 110 divides the image into two by extracting an image of a predetermined range from the image of the reading result. By dividing the image of the reading result into two, one of the images indicates an image of the standard pattern and the other of the images indicates an image of the measurement pattern. A reason for dividing in this manner is that there is a risk that the standard sheet SS and the test sheet TS are set in the scanner 150 tilted respectively, and therefore tilt correction (S133) is performed on these separately.

Image Tilt Detection (S132)

Next, the computer 110 detects the tilt of the images (S132).

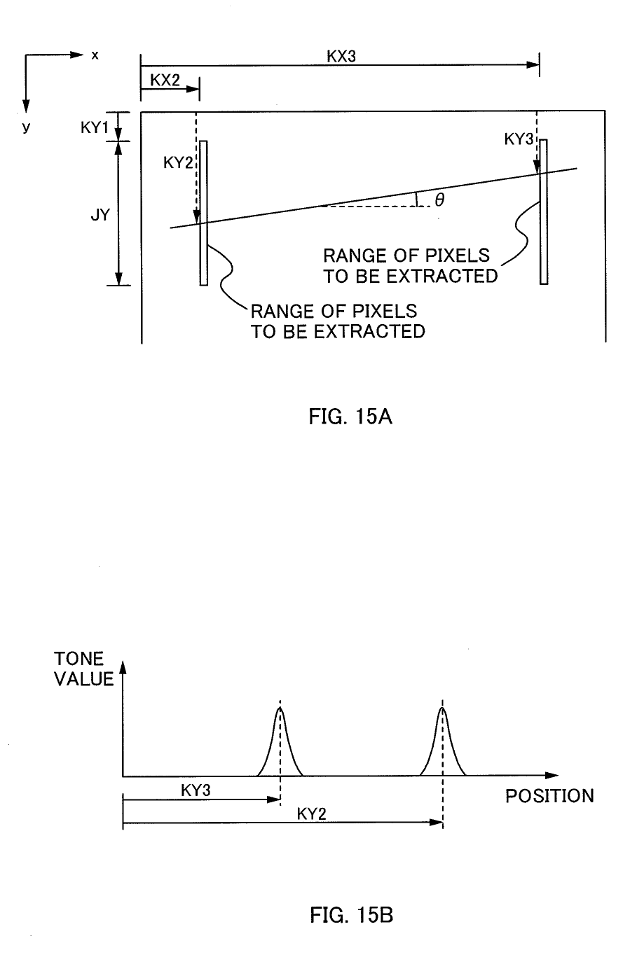

FIG. 15A is an explanatory diagram of a state in which tilt of an image of the measurement pattern is detected. The computer 110 extracts, from the image data, a JY number of pixels from the KY1-th pixel from the top of the KX2-th pixels from the left. Similarly, the computer 110 extracts, from the image data, a JY number of pixels from the KY1-th pixel from the top of the KX3-th pixels from the left. It should be noted that the parameters KX2, KX3, KY1, and JY are set so that pixels indicating the line L1 are contained in the extracted pixels.

FIG. 15B is a graph of tone values of extracted pixels. The horizontal axis indicates pixel positions (Y coordinates). The vertical axis indicates the tone values of the pixels. The computer 110 obtains centroid pixels KY2 and KY3 respectively based on pixel data of the JY number of pixels that have been extracted.

Then, the computer 110 calculates a tilt θ of the line L1 using the following expression:

θ=tan⁻¹{(KY2−KY3)/(KX2−KX3)}

It should be noted that the computer 110 detects not only the tilt of the image of the measurement pattern but also the tilt of the image of the standard pattern. The method for detecting the tilt of the image of the standard pattern is substantially the same as the method above, and therefore description thereof is omitted.

Image Tilt Correction (S133)

Next, the computer 110 corrects the image tilt by performing a rotation process on the image based on the tilt θ detected at S132 (S133). The image of the measurement pattern is rotationally corrected based on a tilt result of the image of the measurement pattern, and the image of the standard pattern is rotationally corrected based on a tilt result of the image of the standard pattern.

A bilinear technique is used in an algorithm for processing rotation of the image. This algorithm is well known, and therefore description thereof is omitted.

Tilt Detection When Printing (S134)

Next, the computer 110 detects the tilt (skew) when printing the measurement pattern (S134). When the lower end of the test sheet passes the transport roller while printing the measurement pattern, sometimes the lower end of the test sheet contacts the head 41 and the test sheet moves. When this occurs, the correction values calculated using this measurement pattern become inappropriate. Consequently, whether or not the lower end of the test sheet has made contact with the head 41 is detected by detecting the tilt at the time of printing the measurement pattern, and if contact has been made, an error is given.

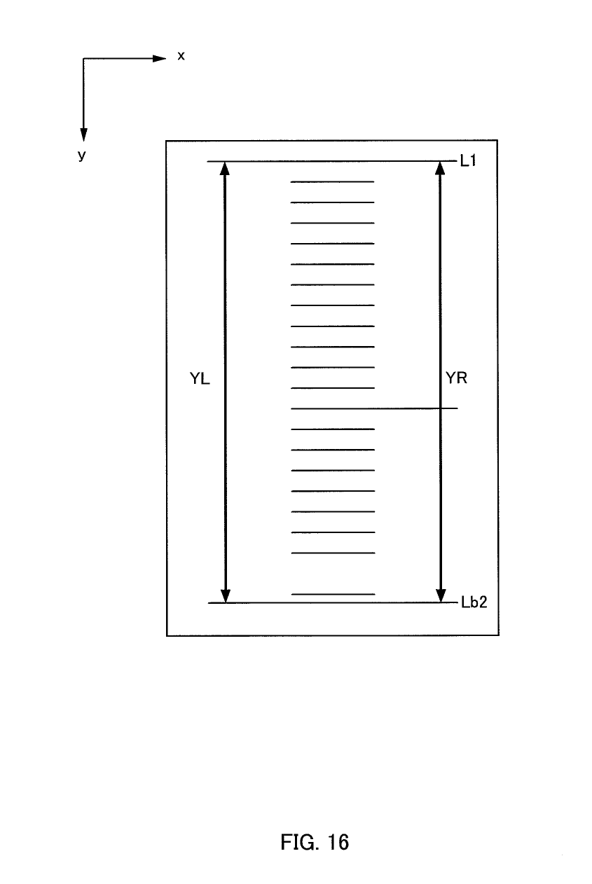

FIG. 16 is an explanatory diagram of a state in which tilt during printing of the measurement pattern is detected. First, the computer 110 detects a left side interval YL and a right side interval YR between the line L1 (the uppermost line) and the line Lb1 (the most bottom line, which is a line formed after the lower end has passed the transport roller)

Then the computer 110 calculates a difference between the interval YL and the interval YR and proceeds to the next process (S135) if this difference is within a predetermined range, but gives an error if this difference is outside the predetermined range.

Calculating an Amount of White Space (S135)

Next, the computer 110 calculates the amount of white space (S135).

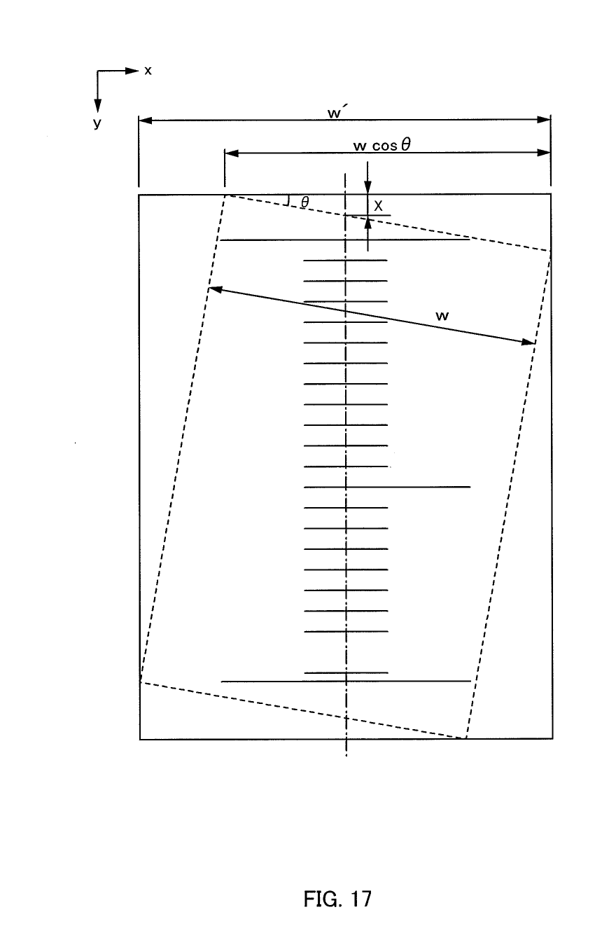

FIG. 17 is an explanatory diagram of a white space amount X. The solid line quadrilateral (outer side quadrilateral) in the diagram indicates an image after rotational correction of S133. The dotted line quadrilateral (inner side diagonal quadrilateral) in FIG. 17 indicates an image prior to the rotational correction. In order to make a rectangular shape of the image after rotational correction, white spaces of right-angled triangle shapes are added to the corners of the rotated image when carrying out rotational correction processing at S133.

Supposing the tilt of the standard sheet SS and the tilt of the test sheet TS are different, the added white space amount will be different, and the positions of the lines in the measurement pattern with respect to the standard pattern will be relatively shifted before and after the rotational correction (S133). Accordingly, the computer 110 obtains the white space amount X using the following expression and prevents displacement of the lines of the measurement pattern with respect to the standard pattern by subtracting the white space amount X from the line positions calculated in S136.

X=(w cos θ−W′/2)×tan θ

Line Position Calculations in Scanner Coordinate System (S136)

Next, the computer 110 calculates the line positions of the standard pattern and the line positions of the measurement pattern respectively using a scanner coordinate system (S136).

The scanner coordinate system refers to a coordinate system when the size of one pixel is 1/720× 1/720 inches. There is reading position error in the scanner 150 and when considering reading position error, strictly speaking the actual region corresponding to the pixel data does not become 1/720 inches× 1/720 inches, but in the scanner coordinate system the size of the region (pixels) corresponding to the pixel data is set to 1/720× 1/720 inches. Furthermore, a position of the upper left pixel in each image is set as an origin in the scanner coordinate system.

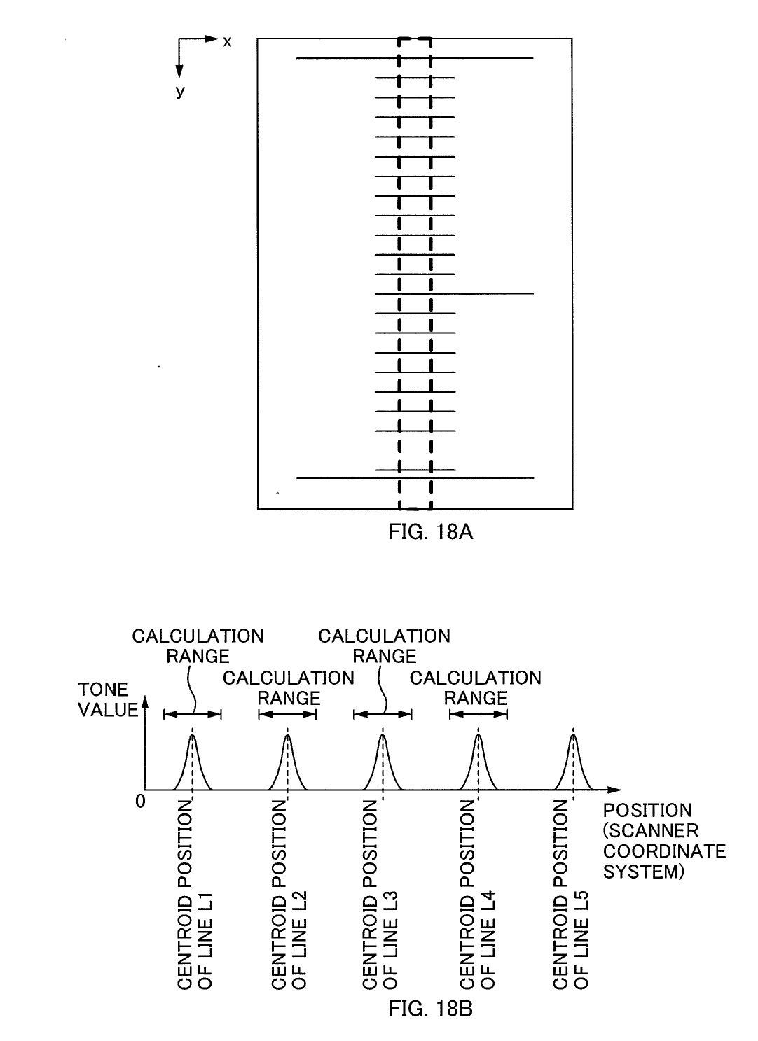

FIG. 18A is an explanatory diagram of an image range used in calculating line positions. The image data of the image in the range indicated by the dotted line in FIG. 18A is used in calculating the line positions. FIG. 18B is an explanatory diagram of calculating line positions. The horizontal axis indicates pixel y direction positions (scanner coordinate system). The vertical axis indicates tone values of the pixels (average values of tone values of pixels lined up in the x direction).

The computer 110 obtains a position of a peak value of the tone values and sets a predetermined calculation range centered on this position. Then, based on the pixel data of pixels in this calculation range, a centroid position of the tone values is calculated, and this centroid position is set as the line position.

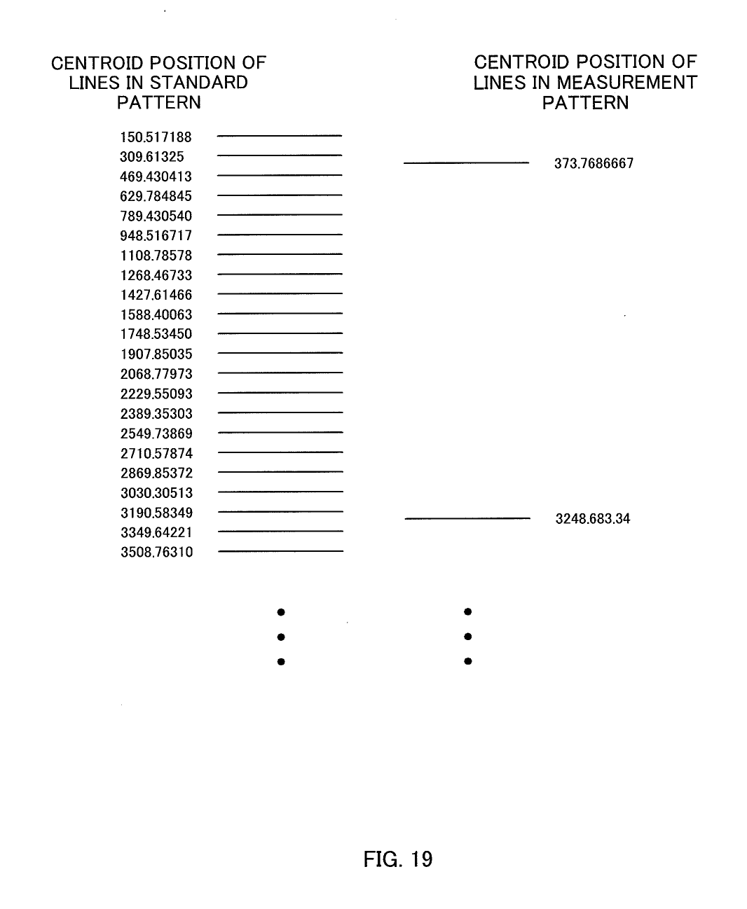

FIG. 19 is an explanatory diagram of calculated line positions (note that positions shown in the diagram have undergone a predetermined calculation to be made dimensionless). In regard to the standard pattern, despite being constituted by lines having uniform intervals, its detected line positions do not have uniform intervals when attention is given to the centroid positions of each line in the standard pattern. This is conceivably an influence of reading position error of the scanner 150.

Calculating Absolute Positions of Lines in Measurement Pattern (S137)

Next, the computer 110 calculates the absolute positions of lines in the measurement pattern (S137).

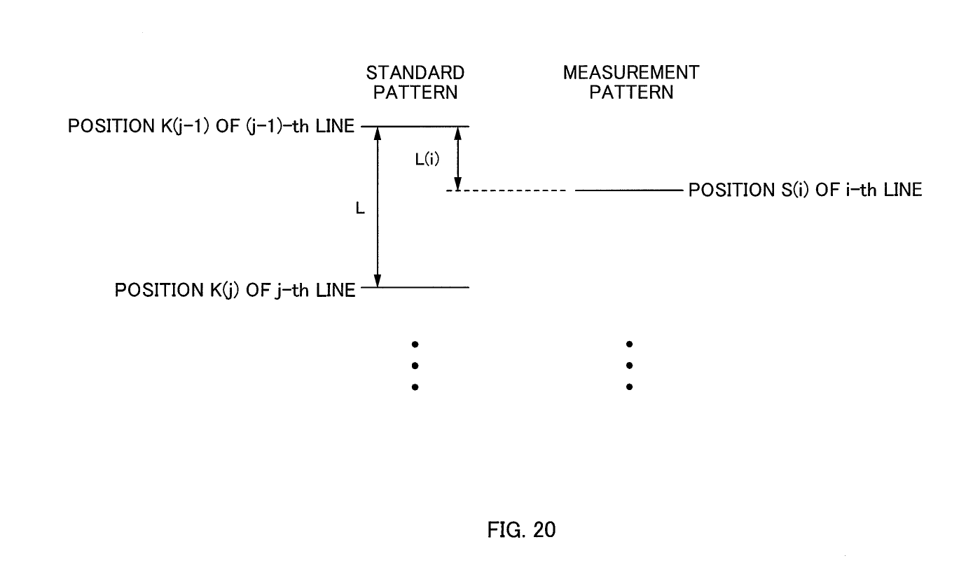

FIG. 20 is an explanatory diagram of calculating absolute positions of an i-th line in the measurement pattern. Here, the i-th line of the measurement pattern is positioned between a (j−1)-th line of the standard pattern and a j-th line of the standard pattern. In the following description, the position (scanner coordinate system) of the i-th line in the measurement pattern is referred to as “S(i)” and the position (scanner coordinate system) of the j-th line in the standard pattern is referred to as “K (j)”. Furthermore, the interval (y direction interval) between the (j−1)-th line and the j-th line of the standard pattern is referred to as “L” and the interval (y direction interval) between the (j−1)-th line of the standard pattern and the i-th line of the measurement pattern is referred to as “L(i).”

First, the computer 110 calculates a ratio H of the interval L(i) to the interval L based on the following expression:

H=L(i)/L=={S(i)−K(j−1)}/{K(j)−K(j−1)}

Incidentally, the standard pattern on the actual standard sheet SS has uniform intervals, and therefore when the absolute position of the first line of the standard pattern is set to zero, the position of an arbitrary line in the standard pattern can be calculated. For example, the absolute position of the second line in the standard pattern is 1/36 inch. Accordingly, when the absolute position of the j-th line in the standard pattern is given as “J(j)” and the absolute position of the i-th line in the measurement pattern is given as “R(i),” R(i) can be calculated as shown in the following expression:

R(i)={J(j)−J(j−1)}×H+J(j−1)

Here, description is given concerning a specific procedure for calculating the absolute position of the first line of the measurement pattern in FIG. 19. First, based on the value (373.768667) of S(1), the computer 110 detects that the first line of the measurement pattern is positioned between the second line and the third line of the standard pattern. Next, the computer 110 calculates that the ratio H is 0.401−43008 (=(373.7686667-309.613250)/(469.430−413−309.613250). Next, the computer 110 calculates that an absolute position R(1) of the first line of the measurement pattern is 0.98878678 mm (=0.038928613 inches={ 1/36 inch}×0.401−43008+ 1/36 inch).

In this manner, the computer 110 calculates the absolute positions of lines in the measurement pattern.

Calculating Correction Values (S138)

Next, the computer 110 calculates correction values corresponding to transport operations of multiple times carried out when the measurement pattern is formed (S138). Each of the correction values is calculated based on a difference between a theoretical line interval and an actual line interval.

The correction value C(i) of the transport operation carried out between the pass i and the pass i+1 is a value in which “R(i+1)−R(i)” (the actual interval between the absolute position of the line Li+1 and the line Li) is subtracted from “6.35 mm” (¼ inch, that is, the theoretical interval between the line Li and the line Li+1). For example, the correction value C(1) of the transport operation carried out between the pass 1 and the pass 2 is 6.35 mm−{R(2)−R(1)}. The computer 110 calculates the correction value C(1) to the correction value C(19) in this manner.

However, when calculating correction values using the lines Lb1 and Lb2, which are below the NIP line (upstream side in the transport direction), the theoretical interval between the line Lb1 and the line Lb2 is taken as “0.847 mm” (= 3/90 inch). The computer 110 calculates the correction value Cb in the non NIP state in this manner.

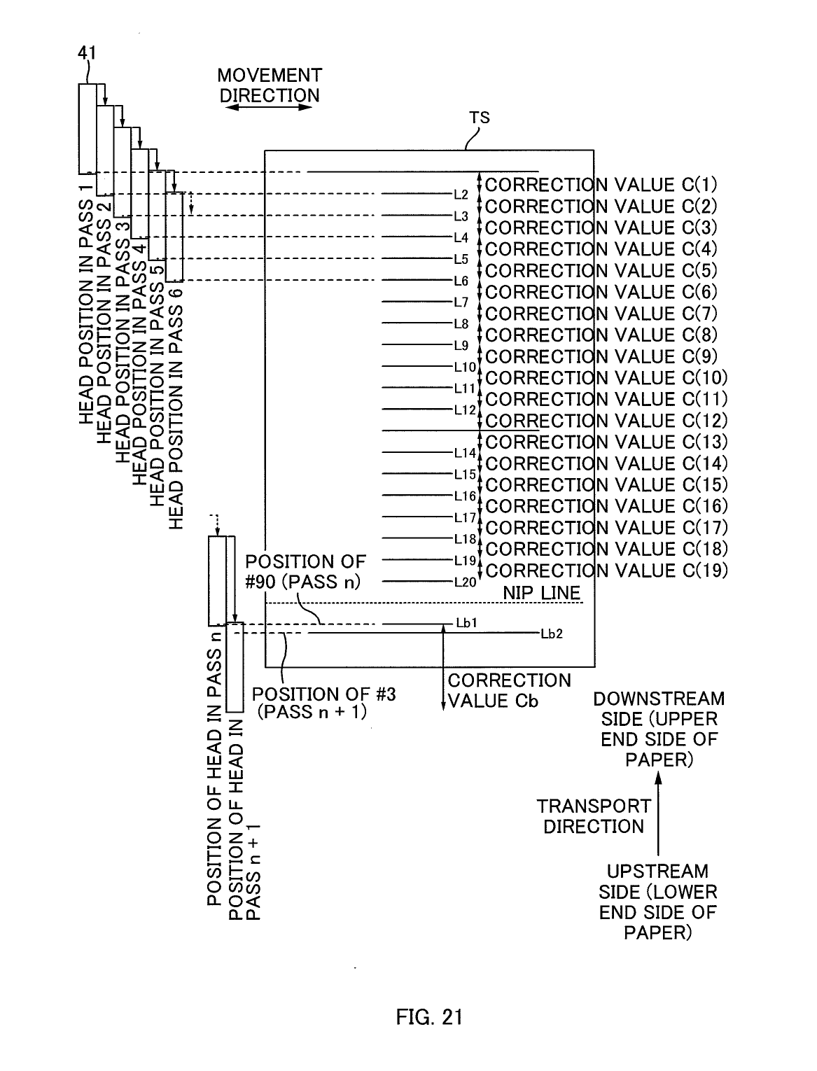

FIG. 21 is an explanatory diagram of a range corresponding to the correction values C(i). Supposing that a value obtained by subtracting the correction value C(1) from the initial target transport amount is set as the target in the transport operation between the pass 1 and the pass 2 when printing the measurement pattern, then the actual transport amount should be comeprecisely ¼ inch (=6.35 mm). Similarly, supposing that a value obtained by subtracting the correction value Cb from the initial target transport amount is set as the target in the transport operation between the pass n and the pass n+1 when printing the measurement pattern, then the actual transport amount should become precisely 1 inch.

Averaging the Correction Values (S139)

In this regard, the rotary encoder 52 of this reference example is not provided with an origin sensor, and therefore although the controller 60 can detect the rotation amount of the transport roller 23, it does not detect the rotation position of the transport roller 23. For this reason, the printer 1 cannot guarantee the rotation position of the transport roller 23 at the commencement of transport. That is, each time printing is performed, there is a risk that the rotation position of the transport roller 23 is different at the commencement of transport. On the other hand, the interval between two adjacent lines in the measurement pattern is affected not only by the DC component transport error when transported by ¼ inch, but is also affected by the AC component transport error.

Consequently, if the correction value C that is calculated based on the interval between two adjacent lines in the measurement pattern is applied as it is when correcting the target transport amount, there is a risk that the transport amount will not be corrected properly due to the influence of AC component transport error. For example, even when carrying out a transport operation of the ¼ inch transport amount between the pass 1 and the pass 2 in the same manner as when printing the measurement pattern, if the rotation position of the transport roller 23 at the commencement of transport is different to that at the time of printing the measurement pattern, then the transport amount will not be corrected properly even though the target transport amount is corrected with the correction value C(1). If the rotation position of the transport roller 23 at the commencement of transport is 180° different compared to the time of printing the measurement pattern, then due to the influence of AC component transport error, not only will the transport amount not be corrected properly, it is possible that the transport error will actually be worsened.

Accordingly, here, in order to correct only the DC component transport error, a correction amount Ca for correcting only DC component transport error is calculated by averaging four correction values C as in the following expression:

Ca(i)={C(i−1)+C(i)+C(i+1)+C(i+2)}/4

Here, description is given of a reason for being able to calculate the correction values Ca for correcting DC component transport error by the above expression.

As stated earlier, the correction value C (i) of the transport operation carried out between the pass i and the pass i+1 is a value in which “R(i+1)−R(i)” (the actual interval between the absolute position of the line Li+1 and the line Li) is subtracted from “6.35 mm” (¼ inch, that is, the theoretical interval between the line Li and the line Li+1). By doing this, the above expression for calculating the correction values Ca possesses a meaning as in the following expression:

Ca(i)=[25.4 mm−{R(i+3)−R(i−1)}]/4

That is, the correction value Ca (i) is a value in which a difference between an interval of two lines that should be separated by one inch theoretically (the line Li+3 and the line Li−1) and one inch (the transport amount of one rotation of the transport roller 23) is divided by four. In other words, the correction value Ca(i) is a value corresponding to the interval between a line Li−1 and a line Li+3, which is formed after one inch of transport has been performed after the forming of the line Li−1.

Therefore, the correction values Ca(i) calculated by averaging four correction values C are not affected by AC component transport error and are values that reflect DC component transport error.

It should be noted that the correction value Ca(2) of the transport operation carried out between the pass 2 and the pass 3 is calculated to be a value obtained by dividing a sum total of the correction values C(1) to C(4) by four (an average value of the correction values C(1) to C(4)). In other words, the correction value Ca(2) is a value corresponding to the interval between the line L1 formed in the pass 1 and the line L5 formed in the pass 5 after one inch of transport has been performed after the forming of the line Ll.

Furthermore, when i−1 becomes zero or less in calculating the correction values Ca(i), C(1) is applied for the correction value C(i−1). For example, the correction value Ca(1) of the transport operation carried out between the pass 1 and the pass 2 is calculated as {C(1)+C(1)+C(2)+C(3)}/4. Furthermore, when i+1 becomes 20 or more in calculating the correction values Ca(i), C(19) is applied for C(i+1) for calculating the correction value Ca. Similarly, when i+2 becomes 20 or more, C(19) is applied for C(i+2). For example, the correction value Ca(19) of the transport operation carried out between the pass 19 and the pass 20 is calculated as {C(18)+C(19)+C(19)+C(19)}/4.

The computer 110 calculates the correction values Ca(1) to the correction value Ca (19) in this manner. In this way, the correction values for correcting DC component transport error are obtained for each ¼ inch range.

Storing Correction Values (S104)

Next, the computer 110 stores the correction values in the memory 63 of the printer 1 (S104).

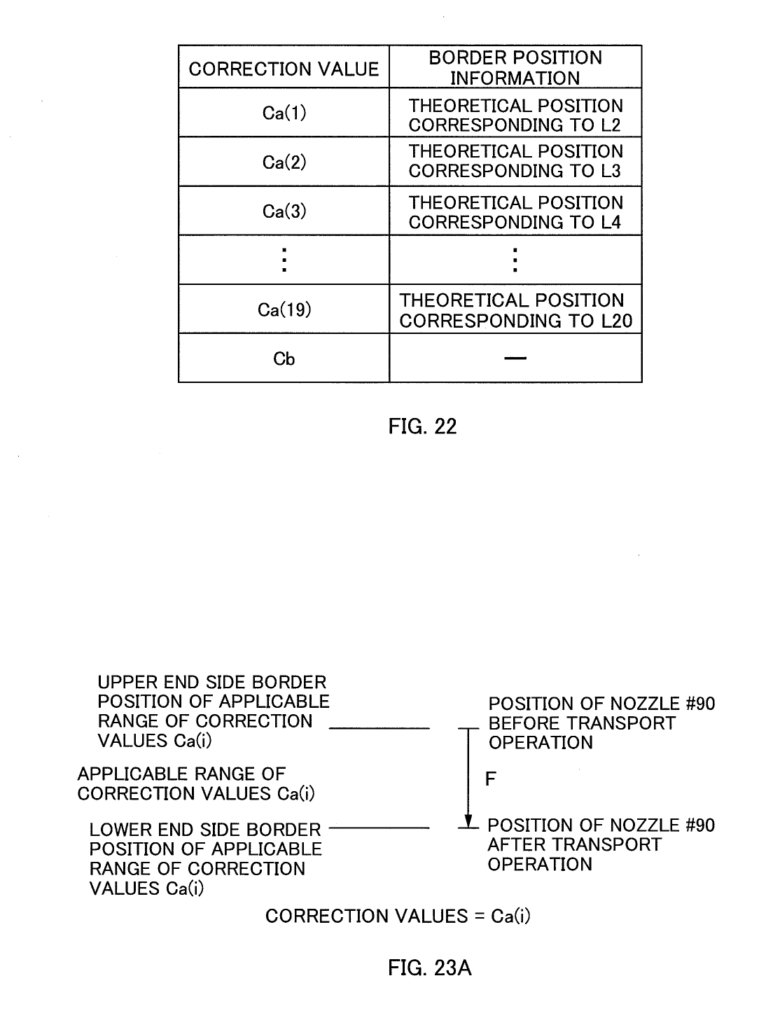

FIG. 22 is an explanatory diagram of a table stored in the memory 63. The correction values stored in the memory 63 are correction values Ca(1) to Ca(19) in the NIP state and the correction value Cb in the non NIP state. Furthermore, border position information for indicating the range in which the correction values are applied is also associated with each correction value and stored in the memory 63.

The border position information associated with the correction values Ca(i) is information that indicates a position (theoretical position) corresponding to the line Li+1 in the measurement pattern, and this border position information indicates a lower end side border of the range in which the correction values Ca (i) are applied. It should be noted that the upper end side border can be obtained from the border position information associated with the correction value Ca (i−1). Consequently, the applicable range of the correction value C(2) for example is a range between the position of the line LI and the position of the line L2 with respect to the paper S (at which nozzle #90 is positioned). It should be noted that the range for the non NIP state is already known, and therefore there is no need to associate border position information with the correction value Cb.

At the printer manufacturing factory, a table reflecting the individual characteristics of each individual printer is stored in the memory 63 for each printer that is manufactured. Then, the printer in which this table has been stored is packaged and shipped.

Transport Operation during Printing by Users

When printing is carried out by a user who has purchased the printer, the controller 60 reads out the table from the memory 63 and corrects the target transport amount based on the correction values, then carries out the transport operation based on the corrected target transport amount. The following is a description concerning a state of the transport operation during printing by the user.

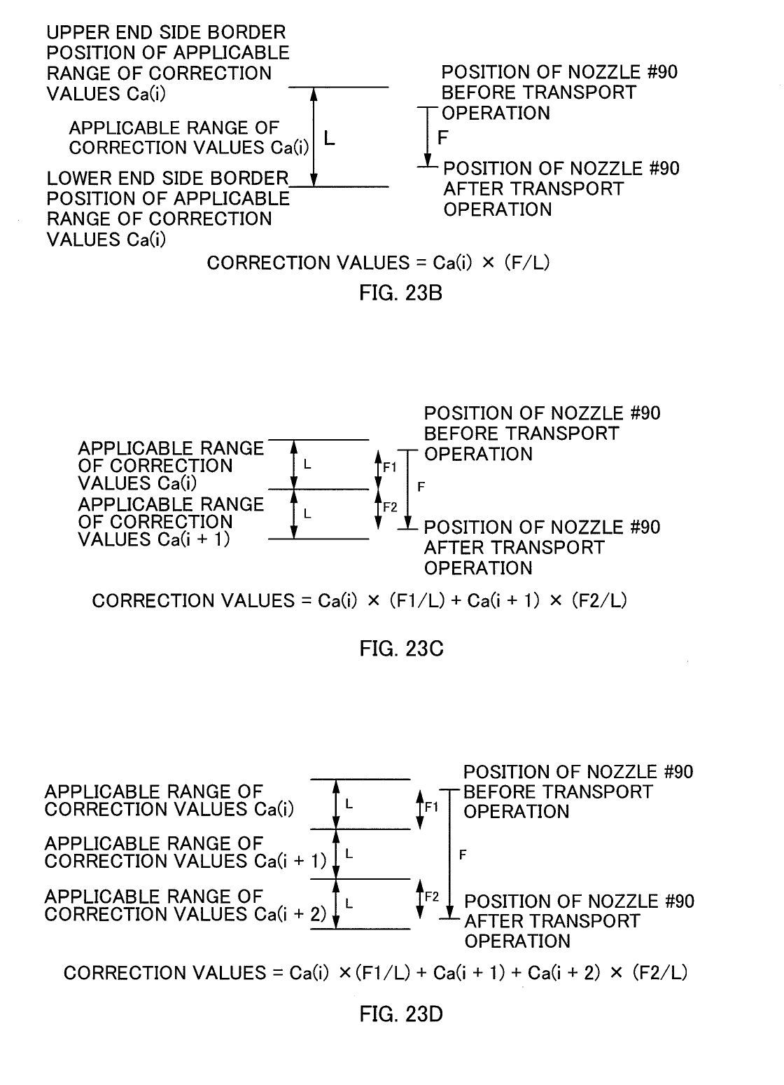

FIG. 23A is an explanatory diagram of correction values in a first case. In the first case, the position of the nozzle #90 before the transport operation (the relative position with respect to the paper) matches the upper end side border position of the applicable range of the correction values Ca(i), and the position of the nozzle #90 after the transport operation matches the lower end side border position of the applicable range of the correction values Ca(i). In this case, the controller 60 sets the correction values to Ca(i), sets as a target a value obtained by adding the correction value Ca (i) to an initial target transport amount F, then drives the transport motor 22 to transport the paper.

FIG. 23B is an explanatory diagram of correction values in a second case. In the second case, the positions of the nozzle #90 before and after the transport operation are both within the applicable range of the correction values Ca(i). In this case, the controller 60 sets as a correction value a value obtained by multiplying a ratio F/L between the initial target transport amount F and a transport direction length L of the applicable range by Ca (i). Then, the controller 60 sets as a target a value obtained by adding the correction value Ca (i) multiplied by (F/L) to the initial target transport amount F, then drives the transport motor 22 and transports the paper.

FIG. 23C is an explanatory diagram of correction values in a third case. In the third case, the position of the nozzle #90 before the transport operation is within the applicable range of the correction values Ca(i), and the position of the nozzle #90 after the transport operation is within the applicable range of the correction values Ca(i+1). Here, of the target transport amounts F, the transport amount in the applicable range of the correction values Ca(i) is set as F1, and the transport amount in the applicable range of the correction values Ca(i+1) is set as F2. In this case, the controller 60 sets as the correction value a sum of a value obtained by multiplying Ca(i) by F1/L and a value obtained by multiplying Ca (i+1) by F2/L. Then, the controller 60 sets as a target a value obtained by adding the correction value to the initial target transport amount F, then drives the transport motor 22 and transports the paper.

FIG. 23D is an explanatory diagram of correction values in a fourth case. In the fourth case, the paper is transported so as to pass the applicable range of the correction values Ca (i+1). In this case, the controller 60 sets as the correction value a sum of a value obtained by multiplying Ca(i) by F1/L, Ca (i+1), and a value obtained by multiplying Ca(i+2) by F2/L. Then, the controller 60 sets as a target a value obtained by adding the correction value to the initial target transport amount F, then drives the transport motor 22 and transports the paper.

In this way, when the controller corrects the initial target transport amount F and controls the transport unit based on the corrected target transport amount, the actual transport amount is corrected so as to become the initial target transport amount F, and the DC component transport error is corrected.

Incidentally, in calculating the correction values as described above, when the target transport amount F is small, the correction value will also be a small value. If the target transport amount F is small, it is conceivable that the transport error produced when carrying out the transport will also be small, and therefore by calculating the correction values in the above manner, correction values that match the transport error produced during transport can be calculated. Furthermore, an applicable range is set for each ¼ inch with respect to the correction values Ca, and therefore this enables the DC component transport error, which fluctuates in response to the relative positions of the paper S and the head 41 to be corrected accurately.

In the foregoing reference example, transport of the paper S could be carried out while correcting the target transport amount using correction values corresponding to the border position information. However, due to memory size restrictions, it is not realistic to store a table of correction values for all combinations of medium types and sizes. For this reason, sometimes there will be no table of correction values stored in the memory for infrequently used combinations of paper types and sizes. Even supposing that a table of correction values for infrequently used combinations of paper types and sizes was stored, an enormous variation of paper types and sizes have been appearing in rapid succession in recent years. Consequently, the correction method of the reference example is unable to support times when transport is carried out for new types and sizes of paper.

Accordingly, depending on whether or not correction values for a supported combination of paper type and size is stored in the memory 63, it is necessary to either carry out transport amount correction using the correction values or carry out transport amount correction using a method other than that. In the following embodiments, the method for correcting the transport amount is varied in response to whether or not there is stored in the memory a table of correction values corresponding to the combination of medium type and size to be printed.

### First Embodiment

In a first embodiment, when carrying out printing in regard to paper of certain combinations of types and sizes, the method for correcting the transport amount is varied for cases in which correction values are stored in the memory 63 corresponding to border position information for those paper combinations and for cases where this is not so.

Broadly described, when there is a table of correction values regarding paper of the combination of a type and size for which printing is being attempted stored in the memory 63, transport of the paper is carried out while correcting the target transport amount using the correction values corresponding to the border position information in a same manner as the foregoing reference example. On the other hand, when a table of correction values regarding paper of the combination of a type and size for which printing is being attempted is not stored in the memory 63, transport of the paper is carried out by correcting the target transport amount based on a fixed correction value.

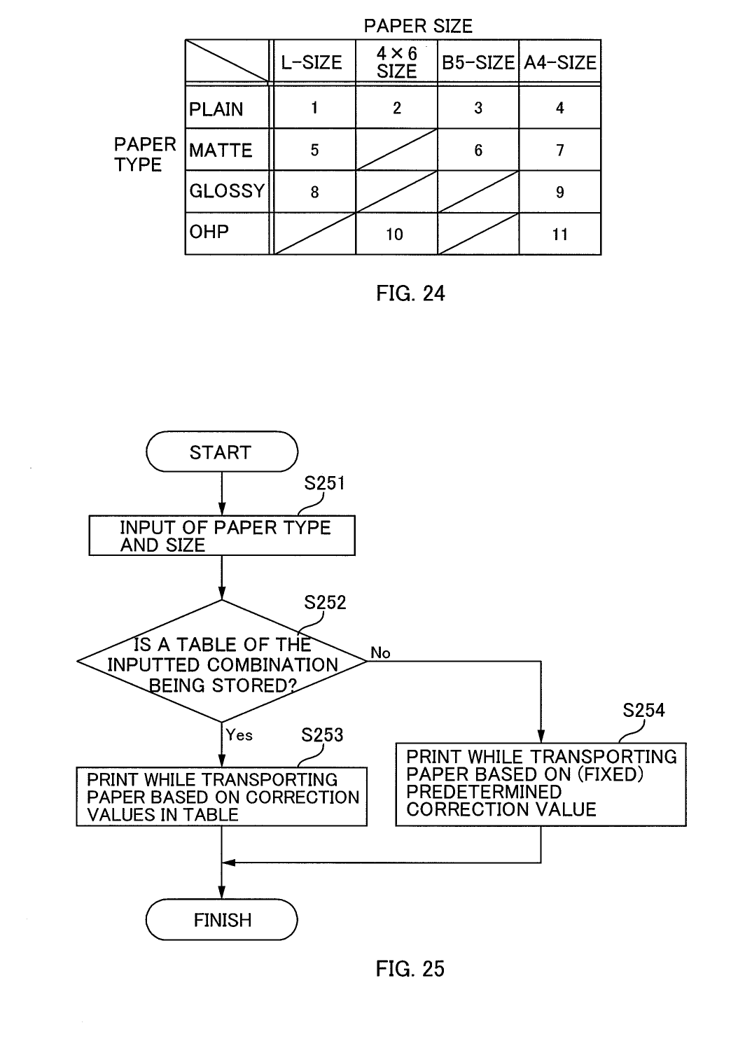

FIG. 24 is a table showing numbers in a correction value table that is stored for combinations of types and sizes of a medium. The table of these individual correction values is a table such as that shown in FIG. 22 earlier for example, and is a table of correction values with respect to border position information. The table of correction values is prepared for each number of corresponding correction value table and these are stored in the memory 63. Here ten types of correction value tables are prepared, which are indicated by “1” to “10” as table numbers. That is, tables of ten types of correction values are stored in the memory 63.

Furthermore, as shown in the diagram, which number table is to be used is established corresponding to combinations of the types and sizes of paper. The table shown in FIG. 24 is stored in the memory 63 and by referencing this it is possible to distinguish whether or not a table of a corresponding combination of paper is stored in the memory 63.

In FIG. 24, paper sizes are shown in a horizontal direction of the table. Here, the size of L-size is 80 mm×110 mm, the size of 4×6 size is 101.6 mm×152.4 mm, the size of B5-size is 182 mm×257 mm, and the size of A4-size is 210 mm×297 mm. Here, four types of size combinations are shown but correction value tables relating to many more sizes of paper (for example, letter size, postcard size or the like) may be stored in the memory 63.

Furthermore, in FIG. 24, paper types are shown in a vertical direction. Here, plain paper, matte paper, glossy paper, and OHP sheet are used as paper types. Here, these four types of papers are shown but correction value tables for many more types of paper than this (for example, special purpose paper for ink ejection type printers or the like) may be stored in the memory 63.

As stated above, in FIG. 24, numbers are shown that indicate the correction value table to be used corresponding to these combinations types and sizes of paper. And stored in the memory 63 corresponding to these table numbers are tables of correction values Ca(1) to Ca(X) (X varies depending on the paper size) corresponding to border position information as in the foregoing reference example.

As shown in the diagram, a reason that the correction value table to be used varies in response to paper size is that the number of correction values to be used also varies in response to paper size. These, the correction values, are stored associated with the border position information. And the border positions have a fixed width of approximately ¼ inch and therefore if the paper size varies, then the number of correction values varies.

Furthermore, the correction value table may vary even for same size papers when the paper type is different. This is because an amount of slippage between the paper and the rollers varies when the paper is different and the correction values have to be varied in response to this. The amount of slippage between the paper and the rollers varies depending on the paper because the coefficient of friction produced between the paper and the rollers varies. For reasons such as this it is necessary to prepare different correction value tables to match the combinations of types and sizes of paper.

Furthermore, in FIG. 24, no table number is indicated for certain combinations among the combinations of types and sizes of paper. For example, no table number is indicated for when there is a combination in which the paper type is OHP sheet and the paper size is L-size. This indicates that there is no table of correction values stored in the memory 63 corresponding to that combination of type and size. This is because in general L-size OHP sheets are rarely used and as such are not stored in the memory 63.

FIG. 25 is a flowchart for describing transport amount corrections according to the first embodiment. Here description is given in regard to how paper transport is carried out while correcting the target transport amount. When an instruction for printing is given from an application running on the computer 110, the computer 110 displays a user interface on the screen and prompts the user to select the type of paper to be printed and the size of the paper to be printed. In response to this, the user selects the type of paper and the size of paper desired to be printed. Data relating to the selected type and size of paper is sent from the computer 110 to the controller 60 of the printer 1 (S251).

When the data relating to the selected type and size of paper is sent to the controller 60, the controller 60 determines whether or not there is a correction value table stored in the memory 63 for that combination of the type and size of paper (S252). This is carried out by referencing an associative table stored in the memory 63 such as that shown in FIG. 24 and determining whether or not there is a corresponding table number. When there is a table of correction values corresponding to the combination of type and size of paper for which printing is being attempted is stored in the memory 63, the controller 60 carries out printing by transporting the paper while correcting the transport amount using the correction values Ca corresponding to the border position information stored in the memory 63.

For example, a determination is made when A4 size plain paper is selected by the user as to whether or not there is a correction value table being stored that corresponds to this. Here, a correction value table having a table number “4” is stored as a corresponding correction value table (FIG. 24). Accordingly, in this case, the controller 60 references the correction value table of table number “4” to carry out printing while transporting the paper based on the correction values in the table (S253). In regard to the specific transport amount correcting method using the correction values Ca corresponding to the border position information, a same method as the reference example is used and therefore description thereof is omitted.

On the other hand, in carrying out printing, when a table of correction values is not stored in the memory 63 corresponding to the combination of the type and size of paper for which printing is being attempted, transport of the paper is carried out while correcting the target transport amount using a fixed value correction value.

Specifically, a new target transport amount is obtained by multiplying the target transport amount by the fixed correction value. Then the controller 60 controls the transport roller and the discharge roller, which are the transport mechanism, in accordance with the new target transport amount. It should be noted that the fixed value correction value in this case is a value stored in advance in the memory 63 that is appropriate to each printer.

For example, when L-size OHP sheet is selected by the user, there is no table number of corresponding correction values. In this case, the controller 60 reads out a predetermined correction value (fixed value) that has been stored in advance in the memory 63 and carries out printing by transporting the paper in accordance with a new target transport amount obtained by multiplying the correction value by the target transport amount (S254).

A following reason is why the target transport amount is corrected using a fixed value correction value when carrying out transport of paper of a type and size combination not stored in the memory 63. For example, in a case such as where the size of the transport roller is produced slightly smaller than the size in the design, it is necessary to transport paper by rotating the transport roller more in order to obtain target transport amounts. In this case, paper transport can be carried out such that transport error per single rotation of the transport roller is corrected by using a fixed correction value that corresponds to error in the size of the transport roller or the like. By doing this, the target transport amount is corrected using the fixed value correction value such that there can be a certain extent of support for correcting at least the transport error produced from error in the size of the transport roller.

By doing this, transport can be carried out, that has been corrected to a certain extent, of a medium other than that of combinations for which correction values are stored, even in a case where correction values for all combinations of medium types and sizes cannot be stored due to memory capacity restrictions.

It should be noted that it is possible as a different embodiment to enable the user to freely input at the user interface sizes of papers other than prescribed sizes. In a case such as this, no table of correction values corresponding to the size of paper will be stored in the memory and therefore correction of the transport amounts can be carried out using the fixed value correction values.

### Second Embodiment

In the first embodiment, correction of the transport amounts was carried out using the fixed value correction values when no corresponding table of correction values was stored in the memory 63. In a second embodiment, even in a case where there is no table number corresponding to the combination of type and size of paper for which printing is being attempted, a table is generated for the paper for which the carrying out of printing is being attempted based on a different table stored in the memory 63, and transport of the paper is carried out by correcting the target transport amounts based on this. This is because correction values corresponding to a small size are contained in tables for papers of larger sizes stored in the memory 63 and therefore a table can be generated based on this for slightly smaller sizes of paper.

Incidentally, slippage between the paper and the rollers as well as the influence applied by to the paper by the repulsive force of the paper itself that is produced when the trailing edge portion of the paper is bent during feeding are conceivable as reasons for which transport error occurs undesirably when transporting paper. The force produced when the trailing edge portion of the paper is bent also varies depending on the strength in the bending of the paper itself. Furthermore, it is conceivable that this will also vary due to the transport direction size of the paper, and this is conceivable since the way the paper bends during feeding varies due to this when the transport direction size of the paper changes.

When the transport error that is produced when the paper is transported is compared to the transport error between papers of the same type having different transport direction sizes, a tendency is evident for the transport error in the vicinity of the end portion of the paper to be consistent. This tendency is very evident between papers having similar sizes. This is conceivably because the way the paper bends during feeding is similar.

Accordingly, even in a case where the size of the paper for which printing is being attempted is slightly smaller than that stored in the memory 63, if the paper for which printing is being attempted is a paper of the same type, it is conceivable that transport amount corrections can be carried out with excellent accuracy by omitting the usage of correction values corresponding to central area vicinities of the paper to carry out paper transport. This involves the amount of bending in the paper being substantially fixed in the central areas of the paper during feeding. And this is because a paper slightly smaller than the paper during feeding is conceivably equivalent to a paper whose central area (the area where the amount of bending is constant) is shorter.

On the other hand, in regard to combinations of types and sizes of paper for which printing is being attempted, when the size of the paper stored in the memory is greatly different even though the type of paper is the same, the way the paper bends during feeding is not similar in the aforementioned manner. Accordingly, there is a tendency that the transport error produced at the end portions of the papers will not be consistent between both of these. Consequently, when the size is greatly different, a method in which usage of correction values corresponding to central area vicinities of the paper is omitted cannot be carried out.

In the second embodiment, characteristics such as these are used such that transport amount corrections are carried out in a following manner when a correction value table for one size larger than the combination of type and size of paper for which printing is being attempted in FIG. 24 is stored in the memory 63. In contrast to this, when a correction value table for two or more sizes larger than the combination of type and size of paper for which printing is being attempted is stored in the memory 63, the transport amounts are corrected using the fixed value correction values.

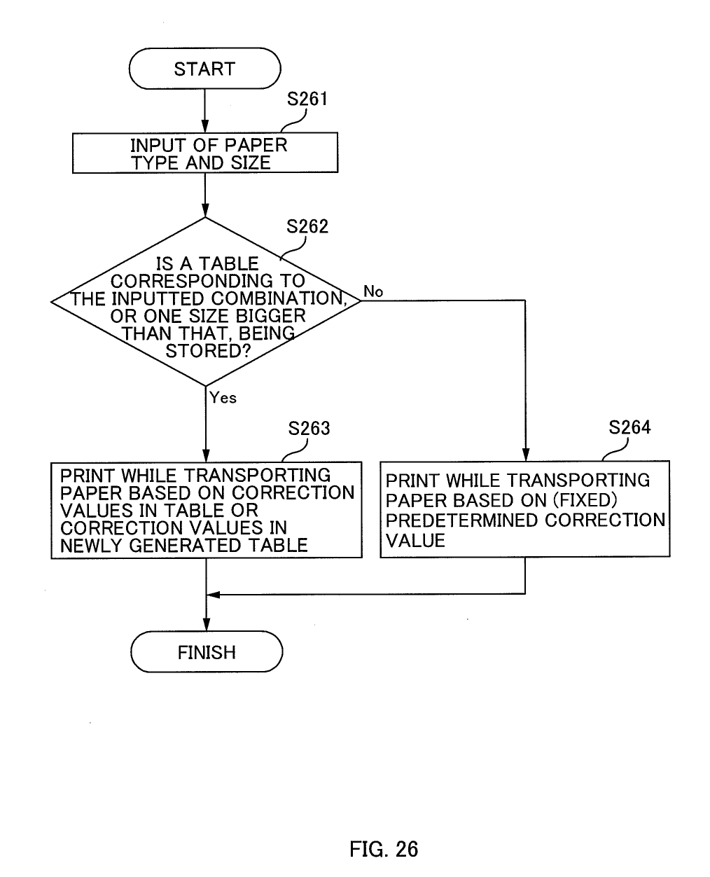

FIG. 26 is a flowchart for describing transport amount corrections according to the second embodiment. Here description is given in regard to how paper transport is carried out while correcting the target transport amount. When an instruction for printing is given from an application running on the computer 110, the computer 110 displays a user interface on the screen and prompts the user to select the type of paper to be printed and the size of the paper to be printed. In response to this, the user selects the type of paper and the size of paper desired to be printed. Data relating to the selected type and size of paper is sent from the computer 110 to the controller 60 of the printer 1 (S261).

When the data relating to the selected type and size of paper is sent to the controller 60, the controller 60 determines whether or not there is a correction value table for that combination of paper type and size stored in the memory or a correction value table of a combination one size larger (FIG. 24) than that combination of paper type and size (S262).

For example, consider a case where printing is to be carried out for an L-size OHP sheet. As shown in FIG. 24, no correction values for L-size OHP sheets are stored in the memory 63, but a correction value table for 4×6 size OHP sheets is stored in the memory 63 (table number “10”). Accordingly, the controller 60 generates a table for L-size correction values in a following manner based on the correction value table of table “10” and carries out transport of the paper based on this (S263).

The correction value table for 4×6 size OHP sheets stored in the memory 63 is similar to that shown in FIG. 22. The table contains correction values Ca(1) to Ca(19) in response to theoretical positions corresponding to L2 to L20. In the second embodiment, numbers of correction values not to be used in generating a correction value table for the L-size size from the 4×6 size are decided in advance.

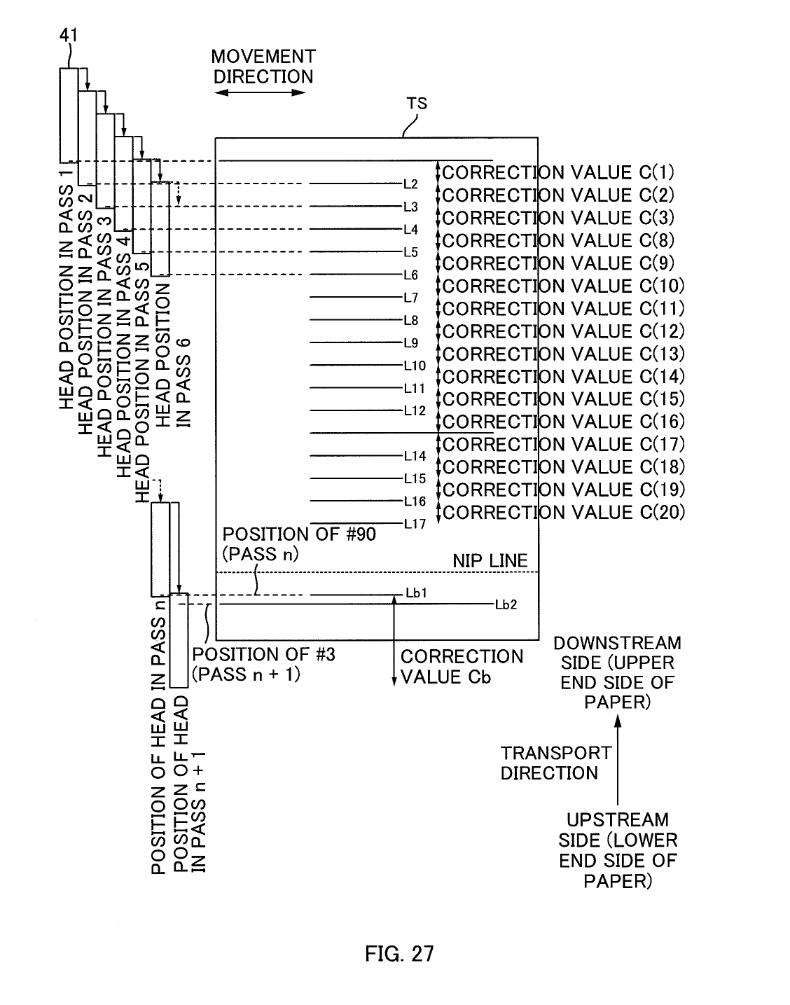

FIG. 27 is an explanatory diagram of a range corresponding to the correction values C(i) in L-size size. Here, Ca(4) to Ca(7) are decided in advance as correction values not to be used. That is, a correction value table generated by deleting Ca(4) to Ca(7) in the correction value table for 4×6 size OHP sheets is used in correcting the transport amounts for L-size.

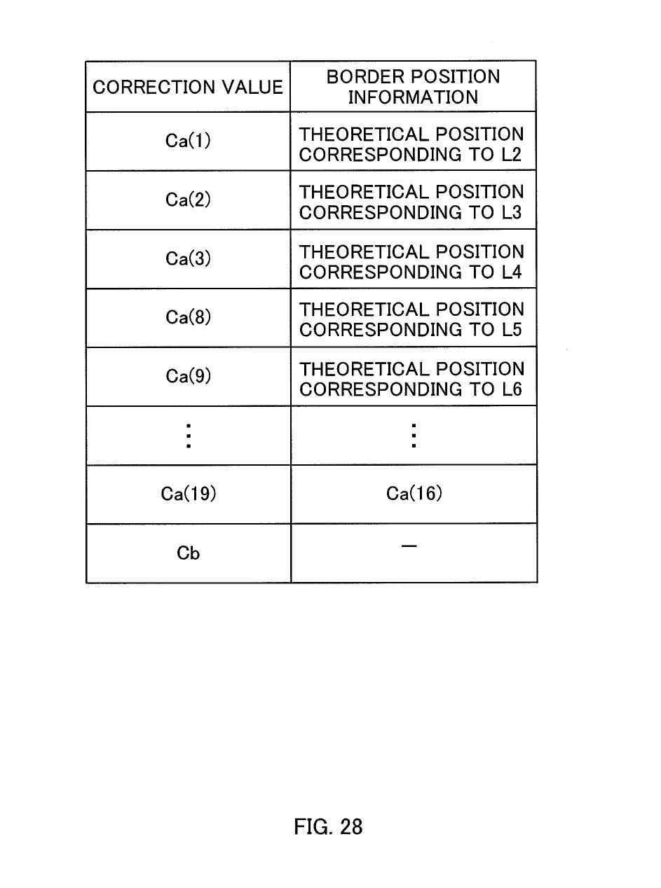

FIG. 28 shows an L-size correction value table generated based on a 4×6 size correction value table. The L-size correction value table that is newly generated in the second embodiment is a correction value table in which Ca(4) to Ca(7) of the 4×6 size correction values Ca(1) to Ca(19) are removed. Accordingly, the Ca(8) to Ca(19) correction values are used in a manner shifted toward the upper end for the portion in which these correction values are removed.

The controller 60 carries out printing by transporting the paper while correcting the target transport amounts using correction values corresponding to the border position information based on the L-size correction value table generated based on the 4×6 size table.

By doing this, transport can be carried out that has been corrected to a certain extent for a medium other than that of combinations for which correction values are stored even in a case where correction values for all combinations of medium types and sizes cannot be stored due to memory capacity restrictions.

Incidentally, in a case where the combination of paper type and size was a combination one size smaller than the table of a combination being stored, transport amount corrections were able to be carried out using the above-described method. On the other hand, in a case where the combination of paper type and size was a combination two or more sizes smaller than the table of a combination being stored, the paper size appeared to be too different and even the extent to which the correction value tendencies matched for end portions of the paper became lower. Accordingly, in this case, transport amount corrections were carried out using the fixed correction values.

In a case such as this, the controller 60 executes a step S264. For example, consider a case where the combination of medium size and type inputted by the user is 4×6 size glossy paper. In this case, there is no table stored in the memory 63 corresponding to the combination of B5-size glossy paper as shown in FIG. 24. And therefore the method involving generating a new correction value table using a portion of a different table as described above cannot be implemented. Accordingly, the controller 60 carries out printing while transporting the paper based on the predetermined (fixed) correction value. This step (S264) involves the same operation as in S254 in the first embodiment, and therefore description thereof is omitted.

By doing this, transport can be carried out that has been corrected to a certain extent for a medium other than that of combinations for which correction values are stored even in a case where correction values for all combinations of medium types and sizes cannot be stored due to memory capacity restrictions.

Furthermore, even for media one size smaller than a paper of a combination of a predetermined size and type stored in the memory 63 it is possible to correct the transport amount using the correction values of a table stored in the memory 63 and therefore highly accurate transport can be achieved.

### Other Embodiments

The foregoing embodiments described primarily a printer. However, it goes without saying that the foregoing description also includes the disclosure of printing apparatuses, recording apparatuses, liquid ejection apparatuses, transport methods, printing methods, recording methods, liquid ejection methods, printing systems, recording systems, computer systems, programs, storage media having a program stored thereon, display screens, screen display methods, and methods for producing printed material, for example.

Also, a printer, for example, serving as an embodiment was described above. However, the foregoing embodiments are for the purpose of elucidating the present invention and are not to be interpreted as limiting the present invention. The invention can of course be altered and improved without departing from the gist thereof and includes functional equivalents. In particular, embodiments described below are also included in the invention.

Regarding the Printer

In the above embodiments a printer was described, however, there is no limitation to this. For example, technology like that of the present embodiments can also be adopted for various types of recording apparatuses that use inkjet technology, including color filter manufacturing devices, dyeing devices, fine processing devices, semiconductor manufacturing devices, surface processing devices, three-dimensional shape forming machines, liquid vaporizing devices, organic EL manufacturing devices (particularly macromolecular EL manufacturing devices), display manufacturing devices, film formation devices, and DNA chip manufacturing devices.

Furthermore, there is no limitation to the use of piezo elements and, for example, application in thermal printers or the like is also possible. Furthermore, there is no limitation to ejecting liquids and application in wire dot printers or the like is also possible.

Overview

(1) A printer 1 as a transport amount correcting apparatus according to the foregoing embodiments is provided with a head 41, a transport unit 20, a memory 63, and a controller 60. The transport unit 20 transports a paper S in a transport direction with respect to the head 41 in accordance with target transport amounts.

Stored in the memory 63 are a plurality of correction values (FIG. 22) for correcting the target transport amount when transporting the paper regarding papers of predetermined combinations of paper types and sizes, these being correction values associated with relative positions between the head 41 and the paper (more specifically, the relative positions between a nozzle #90 and the paper S).

The controller 60 transports the medium in the transport mechanism while correcting the target transport amounts using correction values corresponding to the relative positions at a time of carrying out the transport when carrying out transport for a paper of the predetermined combination (FIG. 23A to 23D). Furthermore, the controller 60 transports the paper in the transport unit 20 while correcting the target transport amount using a fixed correction value when carrying out transport for a paper other than that of the predetermined combinations.

By doing this, transport can be carried out that has been corrected to a certain extent for a paper other than that of combinations for which correction values are stored even in a case where correction values for all combinations of medium types and sizes cannot be stored due to memory capacity restrictions.

(2) Furthermore, with respect to each of the correction values, a range of the relative position to which the correction value should be applied is associated with the correction value. For example, with the above-described correction value Ca (i), the range is associated such that a position (theoretical position) corresponding to the line Li of the measurement pattern is set as the upper end side border position of the applicable range and a position (theoretical position) corresponding to the line Li+1 of the measurement pattern is set as the lower end side border position of the applicable range.

And when the range of correction values corresponding to the relative position before transport is exceeded when performing transport using the target transport amounts, the controller 60 corrects the target transport amounts based on the correction values corresponding to the relative position before transport and the correction values corresponding to the relative position after transport.

In this way, DC component transport error, which fluctuates in response to the relative positions of the paper S and the head 41, can be accurately corrected in response to the transport amounts.

(3) Furthermore, the controller 60 performs correction of the target transport amounts by weighting the correction values in accordance with a ratio between a range in which the relative positions vary when performing transport using the target transport amounts and the range of the relative positions to which the correction values should be applied. For example, in a case such as shown in FIG. 23B, the controller 60 corrects the target transport amounts by weighting the correction values Ca(i) in accordance with a ratio F/L of a range F in which the relative position fluctuates during transport and an applicable range L of the correction values.

In this way, DC component transport error, which fluctuates in response to the relative positions of the paper S and the head 41, can be accurately corrected in response to the transport amounts.

(4) Furthermore, as a transport mechanism, the transport unit 20 is provided with a transport roller 23 and transports the paper S in the transport direction by causing the transport roller 23 to rotate. And each of the correction values are determined based on transport error at a time when the paper S has been transported by causing the transport roller to perform a single rotation, and the range of relative positions to which the correction values should be applied corresponds to the transport amount at a time when the paper S has been transported by causing the transport roller rotate by a rotation amount less than a single rotation. For example, here the range of the relative positions to which the correction values should be applied corresponds to a transport amount of when the paper S has been transported by causing the transport roller to rotate by a rotation amount of ¼ rotation.

By doing this, very fine corrections can be performed on DC component transport error.

(5) Furthermore, when the controller 60 carries out transport for a paper other than the predetermined combinations, a new target transport amount is obtained by multiplying the fixed correction value by the target transport amount, and the paper S is transported by the transport mechanism in response to the new target transport amount. For example, the fixed correction value is determined based on a difference between a size of the transport roller in design and its actual size.

By doing this, even for a case where transport is carried out for a paper other than that of the predetermined combinations or a case where the size of the transport roller varies slightly from the size in design, transport of the paper can be carried out while performing corrections for this.

(6) Furthermore, paper of the predetermined combinations include paper of a certain predetermined combination and paper of different predetermined combinations. And the controller 60 transports the paper by correcting the target transport amounts using correction values corresponding to the relative positions at a time of carrying out the transport when transporting a paper of the certain predetermined combination, and on the other hand, when transporting a paper of the different predetermined combination, the controller 60 transports the paper by correcting the target transport amounts using a portion of the correction values that correspond to the relative positions at a time of transporting the paper of the certain predetermined combination.

By doing this, transport of paper can be carried out by correcting the target transport amounts using a correction value table corresponding to the relative positions when that transport is carried out for papers of the certain predetermined combinations among papers of the predetermined combinations. On the other hand, for papers of different predetermined combinations, a correction value table is generated using a portion of the correction values corresponding to the transport positions of when a medium of the predetermined combinations is transported, and the paper can be transported based on this.

(7) Furthermore, with the transport amount correcting apparatus including all the above-described components, it is possible to attain substantially all of the effects mentioned above, and thus the advantage of the present invention is most effectively realized.

(8) Furthermore, it goes without saying that transport amount correcting methods such as the following are also available. That is, the transport amount correcting method includes a step of determining whether or not correction values are stored in the memory 63 that have been associated with relative positions of the head 41 and the paper S, these being correction values for correcting the target transport amounts when transporting the paper regarding papers of predetermined combinations of paper types and sizes.

Furthermore, the transport amount correcting method includes a step of transporting the medium while correcting the target transport amounts using correction values corresponding to the relative positions at a time of carrying out the transport when carrying out transport for a paper of the predetermined combination, and transporting the paper while correcting the target transport amounts using a fixed correction value when carrying out transport for a paper other than the predetermined combination.

(9) Furthermore, it goes without saying that there is program that runs the above-described transport amount correcting method in a transport amount correcting apparatus.

What is claimed is:

1. A transport amount correcting method, comprising:
(A) determining whether or not correction values associated with relative positions of a head and a medium are stored in a memory, the correction values being correction values for correcting target transport amounts when transporting the medium, the medium being of a predetermined combination of a type and size of the medium; and
(B) transporting, when carrying out transport of the medium of the predetermined combination, the medium while correcting a target transport amount using a correction value corresponding to a relative position at a time of carrying out the transport, and
transporting, when carrying out transport of a medium other than the predetermined combination, the medium while correcting the target transport amount using a fixed correction value.

2. A transport amount correcting method according to claim 1,
wherein with respect to each of the correction values, a range of the relative position to which the correction value should be applied is associated with the correction value, and
in the case the range of the correction value corresponding to the relative position before transport is exceeded when performing transport using the target transport amount, the target transport amount is corrected based on the correction value corresponding to the relative position before transport and the correction value corresponding to the relative position after transport.

3. A transport amount correcting method according to claim 1,
wherein with respect to each of the correction values, a range of the relative position to which the correction value should be applied is associated with the correction value, and
correction of the target transport amount is performed by weighting the correction values in accordance with a ratio between a range in which the relative position varies when performing transport using the target transport amount and the range of the relative position to which the correction value should be applied.

4. A transport amount correcting method according to claim 1,
wherein the medium is transported in a transport direction by causing a transport roller to rotate,
each of the correction values are determined based on transport error when the medium has been transported by causing the transport roller to perform a single rotation, and
a range of the relative position to which the correction value is to be applied corresponds to a transport amount of when the medium has been transported by causing the transport roller to rotate by a rotation amount of less than one rotation.

5. A transport amount correcting method according to claim 1,
wherein when carrying out transport of the medium other than the predetermined combination, a new target transport amount is obtained by multiplying a fixed correction value by the target transport amount and the medium is transported with the transport mechanism in response to the new target transport amount.

6. A transport amount correcting method according to claim 1,
wherein the medium of the predetermined combination includes a medium of a certain predetermined combination and a medium of a different predetermined combination,
when transporting the medium of the certain predetermined combination, the medium is transported by correcting the target transport amount using correction values corresponding to the relative positions at a time of carrying out the transport, and
when transporting the medium of the different predetermined combination, the medium is transported by correcting the target transport amount using a portion of correction values that correspond to the relative positions at a time of transporting the medium of the certain predetermined combination.

7. A transport amount correcting apparatus, comprising:
(A) a head;
(B) a transport mechanism that transports a medium in a transport direction with respect to the head in accordance with a target transport amount that is targeted;
(C) a memory that stores a plurality of correction values associated with relative positions of the head and the medium, the correction values being correction values for correcting target transport amounts when transporting the medium, the medium being of a predetermined combination of a type and size of the medium; and
(D) a controller that, when carrying out transport of the medium of the predetermined combination, causes the transport mechanism to transport the medium while correcting a target transport amount using a correction value corresponding to a relative position at a time of carrying out the transport, and
when carrying out transport of a medium other than the predetermined combination, causes the transport mechanism to transport the medium while correcting the target transport amount using a fixed correction value.

8. A storage medium having a program stored thereon, comprising:
(A) code for determining whether or not correction values associated with relative positions of a head and a medium are stored in a memory, the correction values being correction values for correcting target transport amounts when transporting the medium, the medium being of a predetermined combination of a type and size of the medium; and
(B) code for transporting, when carrying out transport of the medium of the predetermined combination, the medium while correcting a target transport amount using a correction value corresponding to a relative position at a time of carrying out the transport, and
transporting, when carrying out transport of a medium other than the predetermined combination, the medium while correcting the target transport amount using a fixed correction value.
